(19) United States
(12) Patent Application Publication
(10) Pub. No.: US 2024/0217093 A1
(43) Pub. Date: Jul. 4, 2024

(54) ASSIST DEVICE

(71) Applicant: JTEKT CORPORATION, Kariya-shi (JP)

(72) Inventors: Yoshinobu KATO, Toyohashi-shi (JP); Genki MURATA, Shiki-gun (JP); Ai HIGUCHI, Kariya-shi (JP); Atsushi ANDO, Kariya-shi (JP)

(73) Assignee: JTEKT CORPORATION, Kariya-shi (JP)

(21) Appl. No.: 18/562,912

(22) PCT Filed: Dec. 27, 2021
(86) PCT No.: PCT/JP2021/048533

§ 371 Date: Nov. 21, 2023

(30) Foreign Application Priority Data
May 28, 2021 (WO) PCT/JP2021/020426

(51) Int. Cl. B25J 9/00; A61H 3/00; B25J 9/16; B25J 13/08

(52) U.S. Cl. CPC B25J 9/0006; A61H 3/00; B25J 9/163; B25J 9/1638; B25J 13/088

(57) ABSTRACT

An assist device includes: a first wearing tool mounted to at least a waist portion of a user, an assist arm disposed along a thigh portion of the user and being turnable with respect to the first wearing tool; a motor that generates torque for turning the assist arm; a second wearing tool provided on the assist arm and mounted to the thigh portion; an acceleration sensor provided on the first wearing tool; a rotation detector that detects a turning state of the assist arm; and a control device that controls the motor. The control device includes a processing portion that executes an estimation process of obtaining an estimated weight of a load to be lifted by the user based on an output of the acceleration sensor and an output of the rotation detector, and a control process of controlling the motor based on the estimated weight.

### TECHNICAL FIELD

The present invention relates to an assist device.

### BACKGROUND ART

In recent years, there have been proposed a variety of assist devices to be mounted to a body of a user to assist the user in working (see Patent Document 1, for example). Such assist devices are configured to transmit an output of an actuator (motor) to a thigh portion of the user via an arm and assist turning operation of the thigh portion with respect to a waist portion (operation to bend and extend hip joints).

Assist torque to be applied to the user does not need to be large when the weight of a load to be lifted by the user is relatively small, and is preferably adjustable in accordance with the weight of the load. Therefore, an assist device disclosed in Patent Document 1 includes a load sensor provided on a sole or a hand of the user. The assist device is configured to detect the weight of a load detected by the load sensor and adjust assist torque in accordance with the weight of the load.

### RELATED ART DOCUMENTS

### Patent Documents

Patent Document 1: Japanese Unexamined Patent Application Publication No. 2020-93375 (JP 2020-93375 A)

### SUMMARY OF THE INVENTION

### Problem to be Solved by the Invention

In the conventional assist device described above, a dedicated sensor for detecting the weight of the load needs to be provided on a sole etc. that is away from a wearing tool to be worn on the waist portion or the thigh portion, which is a main cause of an increase in cost and makes it difficult for the user to wear the assist device.

Therefore, it is desired to make it possible to control assist torque in accordance with the weight of a load without providing a dedicated sensor for detecting the weight of the load.

### Means for Solving the Problem

An embodiment provides an assist device including: a first wearing tool mounted to at least a waist portion of a user; an arm disposed along a thigh portion of the user and being turnable with respect to the first wearing tool; a motor that generates torque for turning the arm; a second wearing tool provided on the arm and mounted to the thigh portion; an acceleration sensor provided on the first wearing tool; a rotation detector that detects a turning state of the arm; and a control device that controls the motor. The control device includes a processing portion that executes an estimation process of obtaining an estimated weight of a load to be lifted by the user based on an output of the acceleration sensor and an output of the rotation detector, and a control process of controlling the motor based on the estimated weight.

### Effects of the Invention

With the present disclosure, it is possible to control assist torque in accordance with the weight of a load without providing a dedicated sensor for detecting the weight of the load.

### BRIEF DESCRIPTION OF THE DRAWINGS

FIG. 1 is a back view of an assist device worn by a user.

FIG. 2 is a side view of the assist device.

FIG. 3 illustrates the configuration of an actuator.

FIG. 4 is a block diagram illustrating an example of the configuration of a control device.

FIG. 5 illustrates the posture of the user, in which FIG. 5(a) is a side view in which the user is in the upright posture and FIG. 5(b) is a side view in which the user is grasping a load on a loading platform in the squatting posture.

FIG. 6 is a flowchart illustrating a mode of control of a motor performed by a processing portion.

FIG. 7 is a flowchart illustrating an example of an estimation process.

FIG. 8 illustrates the content of first time-series data and second time-series data acquired from discrete value data.

FIG. 9 illustrates load lifting operation and load lowering operation by the user.

FIG. 10 is a graph indicating an example of an arm angular velocity at the time when the user continuously performs the load lifting operation and the load lowering operation.

FIG. 11 is a graph indicating an example of an f1 score at the time when an estimated weight is obtained by varying a threshold and the duration of a previous period.

FIG. 12 is a block diagram illustrating the configuration of a processing portion of an assist device according to a second embodiment.

FIG. 13 is a block diagram illustrating an example of the configuration of a control device according to a third embodiment.

FIG. 14 is a flowchart illustrating an estimation process performed by a processing portion according to the third embodiment.

FIG. 15 illustrates a mode in which first downsampled data and second downsampled data are generated from first time-series data and second time-series data.

FIG. 16 illustrates downsampling performed by the processing portion according to the third embodiment.

FIG. 17 illustrates an operation pattern at the time when the user lifts a load.

FIG. 18 illustrates an operation pattern at the time when the user lifts a load.

FIG. 19 is a flowchart illustrating a mode of control of a motor performed by the processing portion according to the third embodiment.

FIG. 20 illustrates a storage portion of a control device according to a fourth embodiment.

FIG. 21 illustrates operation patterns at the time when the user lifts a load.

FIG. 22 is a flowchart illustrating an estimation process performed by a processing portion according to the fourth embodiment.

FIG. 23 illustrates a mode in which first downsampled data and second downsampled data are generated from first time-series data and second time-series data according to the fourth embodiment.

FIG. 24 is a flowchart illustrating a process related to operation determination and estimated weight computation according to the fourth embodiment.

FIG. 25 illustrates an assist device according to a modification.

### MODES FOR CARRYING OUT THE INVENTION

First, the content of embodiments will be described.

### Overview of Embodiments

(1) An embodiment provides an assist device including: a first wearing tool mounted to at least a waist portion of a user; an arm disposed along a thigh portion of the user and being turnable with respect to the first wearing tool; a motor that generates torque for turning the arm; a second wearing tool provided on the arm and mounted to the thigh portion; an acceleration sensor provided on the first wearing tool; a rotation detector that detects a turning state of the arm; and a control device that controls the motor, in which the control device includes a processing portion that executes an estimation process of obtaining an estimated weight of a load to be lifted by the user based on an output of the acceleration sensor and an output of the rotation detector, and a control process of controlling the motor based on the estimated weight.

According to the above configuration, the estimation process of obtaining an estimated weight of a load to be lifted by the user based on an output of the rotation detector and an output of the acceleration sensor is executed, and thus torque (assist torque) can be controlled in accordance with the weight of the load without providing a dedicated sensor for detecting the weight of the load.

(2) In the above assist device, the estimation process preferably includes an acquisition process of acquiring the output of the rotation detector and the output of the acceleration sensor over time, a determination process of determining whether the output of the rotation detector meets a predetermined condition, and a weight estimation process of obtaining the estimated weight based on first time-series data and second time-series data when it is determined that the output of the rotation detector meets the predetermined condition, the first time-series data being based on a plurality of outputs of the rotation detector acquired in a previous period until a time when the output of the rotation detector that meets the predetermined condition is acquired since a time a predetermined time earlier, and the second time-series data being based on a plurality of outputs of the acceleration sensor acquired in the previous period.

There is a correlation between the output of the rotation detector and the output of the acceleration sensor immediately after the user has started lifting a load and the weight of the load lifted by the user. The output of the rotation detector indicates the turning state of the thigh portion with respect to the waist portion. Hence, the first time-series data and the second time-series data immediately after the user has started lifting a load can be acquired by determining a predetermined condition such that the determination process is performed immediately after the thigh portion has started turning. Hence, the precision in estimating an estimated weight can be enhanced by obtaining an estimated weight using the first time-series data and the second time-series data immediately after the thigh portion has started turning.

(3) In the above assist device, the predetermined condition may be met when an angular velocity of the arm obtained from the output of the rotation detector when the arm is turned in a direction of extending a hip joint of the user becomes more than a threshold set in advance. In this case, the start of turning of the thigh portion can be determined in accordance with the threshold, and the first time-series data and the second time-series data immediately after the user has started lifting a load can be acquired appropriately.

(4) In the above assist device, preferably, the first time-series data include time-series data on an angle of the arm with respect to the first wearing tool and time-series data on an angular velocity of the arm, and the second time-series data include time-series data on an acceleration in an up-down direction at the acceleration sensor and time-series data on an acceleration in a front-rear direction of the user at the acceleration sensor. The estimated weight can be obtained precisely by using such time-series data.

(5) In the above assist device, the weight estimation process preferably includes obtaining the estimated weight using a trained model that has been trained with a relationship between the first time-series data and the second time-series data and a weight of the load. In this case, the precision in estimating an estimated weight can be enhanced better.

(6) In the above assist device, the processing portion may further execute a process of receiving teacher data that indicate the relationship between the first time-series data and the second time-series data and the weight of the load, and a process of retraining the trained model based on the teacher data. In this case, the trained model is retrained using the relationship between the first time-series data and the second time-series data at the time when the user actually lifts the load and the weight of the load as the teacher data, and thus the trained model can be optimized in accordance with the user and, further, the precision of the estimated weight can be enhanced.

(7) In the above assist device, the estimation process may further include an acquisition process of acquiring the output of the rotation detector and the output of the acceleration sensor over time, a muscle torque estimation process of obtaining estimated muscle torque for turning the thigh portion exhibited by muscle power of the user based on an inclination angle and an angular velocity of an upper body of the user obtained from the output of the acceleration sensor and an angle and an angular velocity of the arm obtained from the output of the rotation detector, a determination process of determining whether the output of the rotation detector meets a predetermined condition, and a weight estimation process of obtaining the estimated weight based on a plurality of estimated muscle torques when it is determined that the output of the rotation detector meets the predetermined condition, the plurality of estimated muscle torques being obtained based on a plurality of outputs of the rotation detector and a plurality of outputs of the acceleration sensor acquired in a previous period until a time when the output of the rotation detector that meets the predetermined condition is acquired since a time a predetermined time earlier. In this case, an estimated weight can be obtained based on a plurality of estimated muscle torques obtained in the previous period, and the estimated weight can be obtained precisely.

(8) In the assist device, the estimation process preferably includes an acquisition process of acquiring the output of the rotation detector and the output of the acceleration sensor over time, a determination process of determining whether the output of the rotation detector meets a predetermined condition, an operation determination process of performing operation determination of operation of the user to lift the load based on first time-series data and second time-series data when it is determined that the output of the rotation detector meets the predetermined condition, the first time-series data being based on a plurality of outputs of the rotation detector acquired in a previous period until a time when the output of the rotation detector that meets the predetermined condition is acquired since a time a predetermined time earlier, and the second time-series data being based on a plurality of outputs of the acceleration sensor acquired in the previous period, and a weight estimation process of obtaining the estimated weight based on a determination result of the operation determination, the first time-series data, and the second time-series data. In this case, an estimated weight is obtained based on the determination result of the operation determination for the user, and thus the precision in estimating an estimated weight can be enhanced better.

(9) When the operation determination process includes determining which of a plurality of operation patterns set in advance the operation of the user to lift the load corresponds to, the weight estimation process preferably includes obtaining the estimated weight by selectively using a plurality of trained models that has been trained with a relationship between the first time-series data and the second time-series data and a weight of the load for the plurality of operation patterns. In this case, a trained model that matches the operation pattern of the user can be used, and the precision in estimating an estimated weight can be further enhanced.

(10) The estimation process preferably includes a generation process of generating first downsampled data and second downsampled data when it is determined that the output of the rotation detector meets the predetermined condition, the first downsampled data being obtained by downsampling the first time-series data and the second time-series data at a first sampling rate, and the second downsampled data being obtained by downsampling the first time-series data and the second time-series data at a second sampling rate. In this case, the operation determination process includes performing the operation determination based on the first downsampled data, and the weight estimation process includes obtaining the estimated weight based on the determination result of the operation determination and the second downsampled data. Consequently, the amount of data to be processed in the operation determination process and the weight estimation process can be decreased, and the processing load on the processing portion can be reduced.

(11) When the processing portion further executes a correction process of correcting the estimated weight obtained through the estimation process using a plurality of sigmoid functions corresponding to the plurality of operation patterns, the control process preferably includes using a corrected weight obtained through the correction process as the estimated weight. In this case, the estimated weight can be corrected nonlinearly, and the assist torque can be adjusted to a value that is appropriate for the user.

(12) When the above assist device further includes: a different arm disposed along a different thigh portion of the user and being turnable with respect to the first wearing tool; a different motor that generates torque for turning the different arm; a different second wearing tool provided on the different arm and mounted to the different thigh portion; and a different rotation detector that detects a turning state of the different arm, preferably, the acquisition process includes acquiring an output of the different rotation detector over time in addition to the output of the rotation detector and the output of the acceleration sensor, and the first time-series data include time-series data on a first value based on the output of the rotation detector, time-series data on a second value based on the output of the different rotation detector, and time-series data on an average value of the first value and the second value. In this case, operation of the user U can be determined more particularly by selectively using the time-series data, and the number of operation patterns to be determined can be increased.

### Details of Embodiments

Preferable embodiments will be described below with reference to the drawings.

### First Embodiment

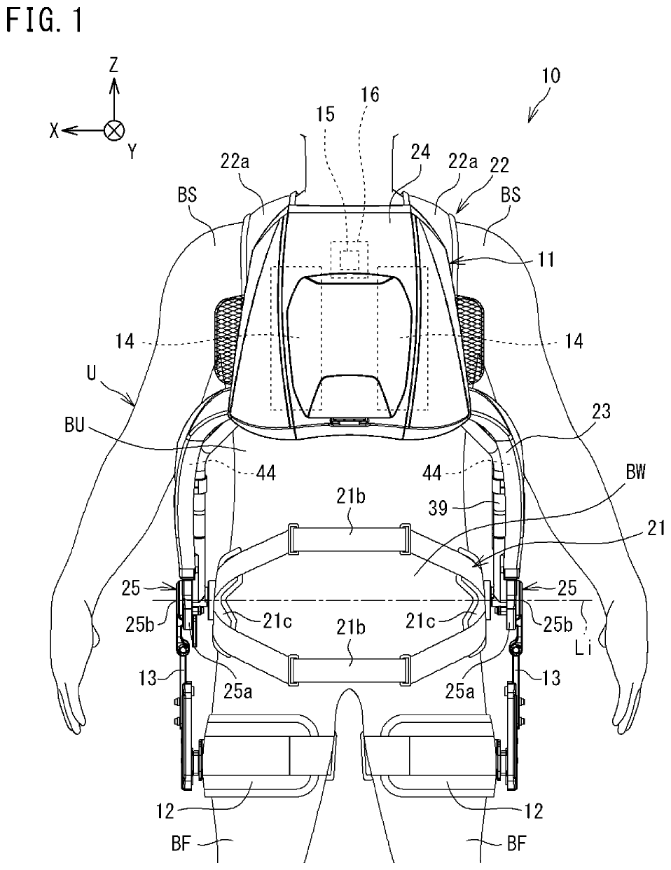

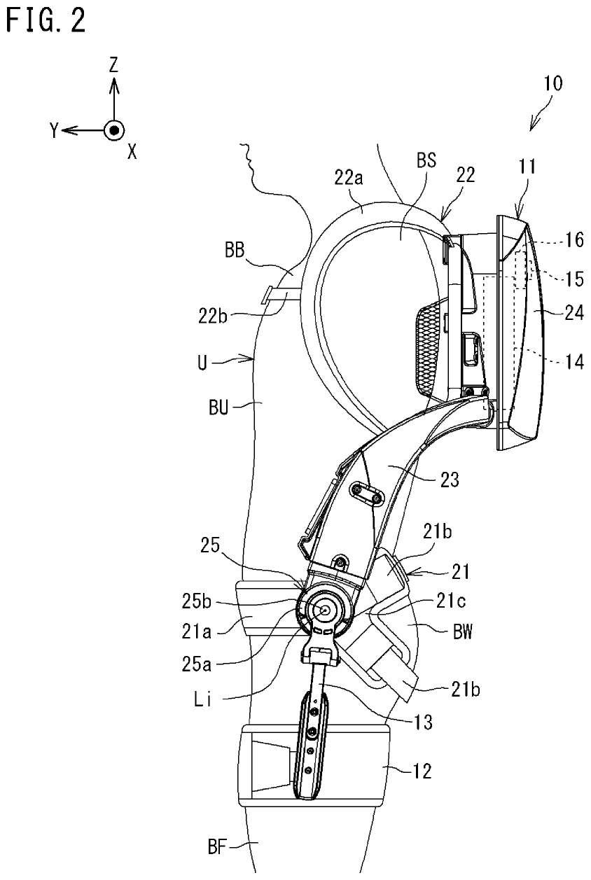

FIG. 1 is a back view of an assist device worn by a user, and FIG. 2 is a side view of the assist device. An assist device 10 according to a first embodiment assists a user U in turning thigh portions BF with respect to a waist portion BW (operation to bend and extend hip joints) when the user U lifts and lowers a load, for example, and assists the user U in turning the thigh portions BF with respect to the waist portion BW when the person walks. The operation of the assist device 10 to assist a body of the user U is referred to as “assist operation”.

In the drawings, of an X direction, a Y direction, and a Z direction that are orthogonal to each other, the Z direction is parallel to the vertical direction. The Y direction is the front-rear direction of the user U wearing the assist device 10 and in the upright posture. The X direction is the right-left direction of the user U wearing the assist device 10 and in the upright posture. Regarding the assist operation, an assist of turning of the thigh portions BF with respect to the waist portion BW described above is the same as an assist of turning of the waist portion BW with respect to the thigh portions BF. The assist operation is operation to apply, to the user U, torque about a virtual axis Li that passes through the waist portion BW of the user U and that is parallel to the X direction. This torque is also referred to as “assist torque”.

The assist device 10 illustrated in FIG. 1 includes a first wearing tool 11, a pair of second wearing tools 12, and a pair of assist arms 13. The first wearing tool 11 is mounted to an upper body BU of the user U, including the waist portion BW. The pair of second wearing tools 12 is mounted to the right and left thigh portions BF of the user U.

The first wearing tool 11 includes a waist support portion 21, a jacket portion 22, a frame pipe 39, a backpack portion 24, and a pair of turning mechanisms 25. The waist support portion 21 is mounted around the waist portion BW of the user U. The waist support portion 21 includes a front belt 21a, a pair of rear belts 21b, and a pair of waist side pads 21c. The front belt 21a and the pair of rear belts 21b fix the pair of waist side pads 21c to both sides of the waist portion BW of the user U.

The pair of turning mechanisms 25 is fixed to the pair of waist side pads 21c. One of the pair of turning mechanisms 25 is fixed to the right waist side pad 21c, and the other is fixed to the left waist side pad 21c. A pair of assist arms 13 are turnably fixed to the pair of turning mechanisms 25. Each turning mechanism 25 includes a case 25a fixed to the waist side pad 21c and a driven pulley (not illustrated) that is housed inside the case 25a and that is turnable with respect to the case 25a. The driven pulley includes a shaft portion 25b that is rotatable together with the driven pulley. The shaft portion 25b projects out of the case 25a from a surface of the case 25a opposite to a surface that faces the user U. The assist arm 13 is fixed to the shaft portion 25b. Hence, the driven pulleys and the pair of assist arms 13 are turnable together. This enables the pair of assist arms 13 to be turned with respect to the first wearing tool 11.

The jacket portion 22 is mounted around shoulder portions BS and a chest BB of the user U. The jacket portion 22 includes a pair of shoulder belts 22a and a chest belt 22b. The pair of shoulder belts 22a is coupled to the frame pipe 39. The frame pipe 39 is fixed to the back of the user U by the pair of shoulder belts 22a. The chest belt 22b couples the pair of shoulder belts 22a in front of the chest BB of the user U. The frame pipe 39 is fixed to the back of the user U more securely by the chest belt 22b.

The frame pipe 39 is provided in a U-shape. The frame pipe 39 passes between the back of the user U and the backpack portion 24 to connect the turning mechanisms 25 disposed on the right and left sides of the user U. The backpack portion 24 is fixed to the frame pipe 39. The pair of turning mechanisms 25 is fixed to both ends of the frame pipe 39, and fixed to the pair of waist side pads 21c. At this time, the turning center of the pair of assist arms 13 coincides with the virtual axis Li in the right-left direction of the user U that passes through the waist portion BW of the user U.

The pair of second wearing tools 12 is mounted around the right and left thigh portions BF of the user U. The second wearing tools 12 are belt-like members made of a resin, leather, cloth, etc., and are wound around the thigh portions BF to be mounted and fixed to the thigh portions BF. The distal end portions of the assist arms 13 are attached to the second wearing tools 12. The pair of assist arms 13 extends from the pair of turning mechanisms 25 along both sides of the user U. Hence, the pair of assist arms 13 connects the pair of second wearing tools 12 and the first wearing tool 11. The pair of second wearing tools 12 fixes the distal end portions of the pair of assist arms 13 to both the thigh portions BF of the user U. Consequently, the pair of assist arms 13 is disposed along both the thigh portions BF of the user U to turn together with both the thigh portions BF.

The assist device 10 further includes a pair of actuators 14, an acceleration sensor 15, and a control device 16. The pair of actuators 14, the acceleration sensor 15, and the control device 16 are housed in the backpack portion 24. Besides these, a battery (not illustrated) for supplying necessary power to various portions is also housed in the backpack portion 24.

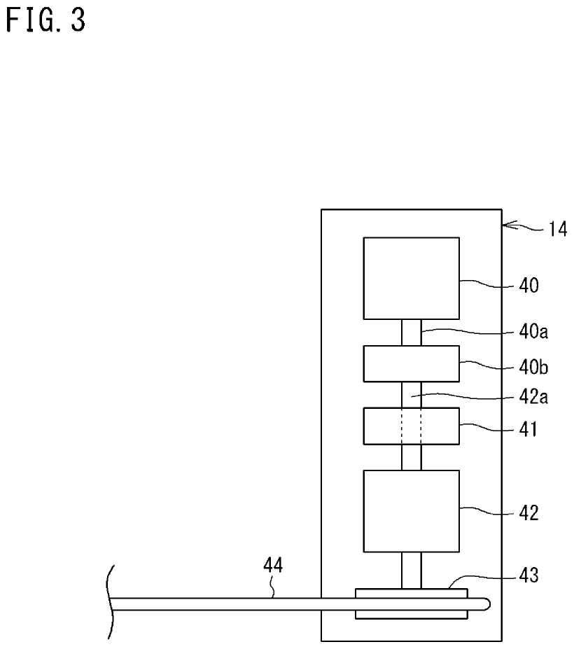

Each actuator 14 has a function to generate assist torque for turning the assist arm 13 with respect to the first wearing tool 11. FIG. 3 illustrates the configuration of the actuator 14. In FIG. 3, the configuration of the actuator 14 is illustrated as simplified. The actuator 14 includes a motor 40, a spiral spring 40b, a rotation detector 41, a speed reducer 42, and a driving pulley 43. The motor 40 generates torque for turning the assist arm 13. The motor 40 outputs rotational force from an output shaft 40a. The motor 40 is controlled by the control device 16. One end of the spiral spring 40b is connected to the output shaft 40a of the motor 40. Meanwhile, the other end of the spiral spring 40b is connected to an input shaft 42a of the speed reducer 42. This allows the spiral spring 40b to transfer the rotational force of the motor 40 to the speed reducer 42.

The speed reducer 42 has a function to reduce the speed of the rotational force of the motor 40. The rotational force of the motor 40 is transferred to the input shaft 42a via the spiral spring 40b. The rotational force of the motor 40 that has been reduced in speed is transferred to the driving pulley 43. The rotation detector 41 has a function to detect the rotational state of the input shaft 42a of the speed reducer 42, and detects the turning state of the assist arm 13. The rotation detector 41 is a rotary encoder, a Hall sensor, a resolver, etc. An output of the rotation detector 41 is provided to the control device 16.

The driving pulley 43 is rotationally driven by the rotational force of the motor 40 that has been reduced in speed by the speed reducer 42. A wire 44 is fixed to the driving pulley 43. The wire 44 passes inside a protective tube (not illustrated) that extends along the frame pipe 39, and is connected to one of the pair of turning mechanisms 25 (FIG. 1). One end of the wire 44 is fixed to the driving pulley 43. The other end of the wire 44 is fixed to the driven pulley of the turning mechanism 25. Hence, the rotational force of the driving pulley 43 is transferred to the driven pulley of the turning mechanism 25 via the wire 44. The wire 44 is protected by a frame cover 23 disposed along the frame pipe 39.

The driven pulley of the turning mechanism 25 is turned by rotational force from the driving pulley 43. Consequently, the assist arm 13 capable of turning together with the driven pulley is also turned. In this manner, the rotational force of the motor 40 is transferred to the turning mechanism 25 via the driving pulley 43, the wire 44, and the driven pulley to be used as torque for turning the assist arm 13.

As illustrated in FIG. 1, the pair of actuators 14 is disposed side by side on the right and left sides in the backpack portion 24. The left actuator 14, of the pair of actuators 14, is connected to the left turning mechanism 25, of the pair of turning mechanisms 25, to transfer rotational force to the left turning mechanism 25. The right actuator 14, of the pair of actuators 14, is connected to the right turning mechanism 25, of the pair of turning mechanisms 25, to transfer rotational force to the right turning mechanism 25.

The acceleration sensor 15 is a three-axis acceleration sensor that detects acceleration in each of the directions of the three axes that are orthogonal to each other. The acceleration sensor is mounted on a substrate of the control device 16, and fixed in the backpack portion 24, for example. An output of the acceleration sensor 15 is provided to the control device 16.

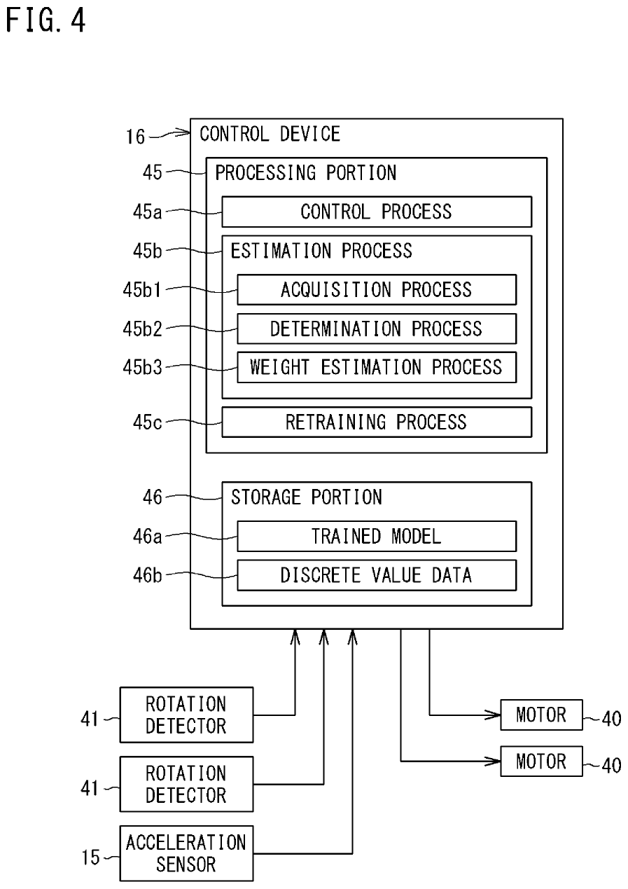

The control device 16 is fixed and housed in the backpack portion 24. The control device 16 is constituted of a computer etc. FIG. 4 is a block diagram illustrating an example of the configuration of the control device 16. As illustrated in FIG. 4, the control device 16 includes a processing portion 45 such as a processor and a storage portion 46 such as a memory or a hard disk.

The storage portion 46 stores a computer program to be executed by the processing portion 45 and necessary information. The processing portion 45 implements various processing functions of the processing portion 45 by executing a computer program stored in a non-transitory computer-readable storage medium such as the storage portion 46. The storage portion 46 also stores a trained model 46a and discrete value data 46b to be discussed later.

The processing portion 45 can execute a control process 45a, an estimation process 45b, and a retraining process 45c by executing the computer program discussed above. The estimation process 45b includes an acquisition process 45b1, a determination process 45b2, and a weight estimation process 45b3. These processes will be described later.

### [Acquisition Process]

The processing portion 45 obtains values and information that are necessary for various processes by acquiring an output of the acceleration sensor 15 and outputs of both the right and left rotation detectors 41 over time by executing the acquisition process 45b1 (FIG. 4).

The processing portion 45 obtains acceleration in the Y direction at the acceleration sensor 15 and acceleration in the Z direction at the acceleration sensor 15 based on the output of the acceleration sensor 15. The acceleration sensor 15 is a three-axis acceleration sensor that detects acceleration in each of the directions of the three axes that are orthogonal to each other as discussed above. Hence, the processing portion 45 can obtain acceleration in the Y direction at the acceleration sensor 15 and acceleration in the Z direction at the acceleration sensor 15 based on the output of the acceleration sensor 15. The acceleration sensor 15 is housed and fixed in the backpack portion 24. Hence, the acceleration in the Y direction at the acceleration sensor 15 and the acceleration in the Z direction at the acceleration sensor 15 indicate acceleration in the Y direction and acceleration in the Z direction of the upper body BU of the user U. In the following description, the acceleration in the Y direction at the acceleration sensor 15 will be simply referred to as “Y-direction acceleration”, and the acceleration in the Z direction at the acceleration sensor 15 will be simply referred to as “Z-direction acceleration”.

In addition, the processing portion 45 can three-dimensionally obtain the inclination angle of the acceleration sensor 15 with respect to the vertical direction (direction of acceleration of gravity) based on the output of the acceleration sensor. Hence, the processing portion 45 can also obtain the inclination angle of the upper body BU with respect to the vertical direction.

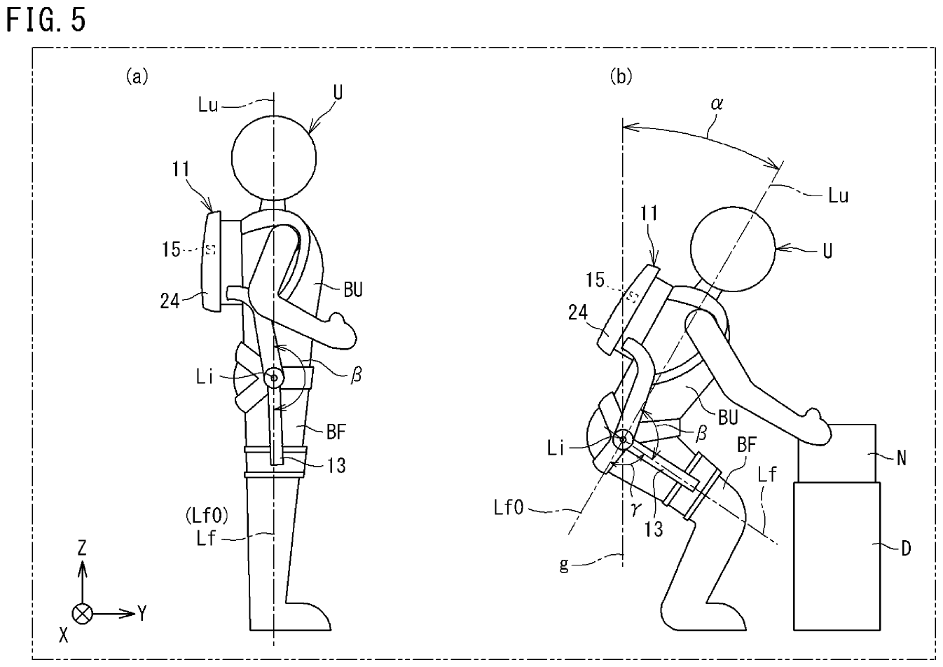

FIG. 5 illustrates the posture of the user, in which FIG. 5(a) is a side view in which the user U is in the upright posture and FIG. 5(b) is a side view in which the user U is grasping a load N on a loading platform D in the squatting posture. FIG. 5(b) illustrates a state in which the user U is in a squatting posture with hip joints and knee joints bent.

As illustrated in FIGS. 5(a) and 5(b), a virtual line Lu that extends along the upper body BU from the virtual axis Li is defined as a line that indicates the direction of inclination of the first wearing tool 11 (upper body BU) with respect to the vertical direction. The virtual line Lu is defined as being parallel to the vertical direction when the user U is in the upright posture. The virtual line Lu is inclined in accordance with inclination of the first wearing tool 11 (upper body BU). As illustrated in FIGS. 5(a) and 5(b), a virtual line Lf that extends along the assist arms 13 from the virtual axis Li is defined as a line that indicates the angular position of the assist arms 13 (thigh portions BF) with respect to the first wearing tool 11. The virtual line Lf is defined as being parallel to the vertical direction when the user U is in the upright posture. The virtual line Lf is turned in correspondence with turning of the assist arms 13 with respect to the first wearing tool 11.

When the user U takes the squatting posture as in FIG. 5(b), the virtual line Lu (upper body BU) is inclined to be leaned forward. Meanwhile, the virtual line Lf (thigh portions BF) are inclined to be leaned rearward.

In FIG. 5(b), an inclination angle α of the upper body BU with respect to the vertical direction is represented by the virtual line Lu and a vertical direction line g that passes through the virtual axis Li and that is parallel to the vertical direction. As discussed above, the processing portion 45 can obtain the inclination angle α based on the output of the acceleration sensor 15.

In FIGS. 5(a) and 5(b), in addition, an arm angle β is the angle of the assist arms 13 (thigh portions BF) relative to the first wearing tool 11 (upper body BU), and is the angle between the virtual line Lu and the virtual line Lf. That is, the arm angle β indicates the angle of the hip joints of the user U.

The processing portion 45 obtains the arm angle β and an arm angular velocity ω based on the outputs of the rotation detectors 41. The arm angular velocity ω is the angular velocity of the assist arms 13 at the time when the assist arms 13 are turned with respect to the first wearing tool 11. The processing portion 45 can obtain the angle and the angular velocity of the input shaft 42a, as the rotational state of the speed reducer 42, based on the outputs of the rotation detectors 41. The angle of the input shaft 42a indicates the accumulated angle of input shaft 42a.

Here, the rotational force of the motor 40 is transferred to the assist arm 13 via the speed reducer 42, the driving pulley 43, the wire 44, and the turning mechanism 25. Hence, the rotation of the motor 40 and the speed reducer 42 and the rotation of the assist arm 13 correspond to each other at certain proportions. That is, the angle and the angular velocity of the input shaft 42a can be converted into the angle and the angular velocity of the assist arm 13 relative to the first wearing tool 11. Consequently, the processing portion 45 can obtain the angle and the angular velocity of the assist arm 13 (thigh portion BF) relative to the first wearing tool 11 based on the output of the rotation detector 41. The output of the rotation detector 41 includes not only an output at the time when the motor 40 and the speed reducer 42 are outputting rotational force, but also an output at the time when the input shaft 42a of the speed reducer 42 is rotated by turning of the assist arm 13 when the assist arm 13 is turned with respect to the first wearing tool 11.

For example, the angular position of the assist arms 13 with respect to the first wearing tool 11 at the time when the user U is in the upright posture is considered as a state in which the hip joints are extended, and this angular position is defined as a reference angular position. In FIG. 5(a), the user U is in the upright posture, and thus a virtual line Lf0 that indicates the reference angular position and the virtual line Lf overlap each other. In addition, the arm angle β at the time when the angular position of the assist arms 13 (virtual line Lf) is the reference angular position is defined as 180 degrees.

In FIG. 5(b), on the other hand, the assist arms 13 are turned toward the upper body BU. Hence, the virtual line Lf is turned toward the upper body BU with respect to the virtual line Lf0. The processing portion 45 can obtain the arm angle β by obtaining an angle γ between the virtual line Lf0 as the reference angular position and the virtual line Lf and subtracting the angle γ from 180 degrees. In this manner, the processing portion 45 can obtain the arm angle β based on the virtual line Lf0 indicating the reference angular position.

The arm angular velocity ω at the time when the thigh portion BF is turned with respect to the upper body is obtained based on the increment of the arm angle β per unit time by acquiring the arm angle β over time.

In the manner described above, the processing portion 45 obtains the Y-direction acceleration and the Z-direction acceleration based on the acquired output of the acceleration sensor 15. In addition, the processing portion 45 obtains the arm angle β and the arm angular velocity ω based on the acquired output of the rotation detector 41. The processing portion 45 obtains the arm angle β and the arm angular velocity ω for each of the right and left assist arms 13.

The processing portion 45 acquires the output of the acceleration sensor 15 and the outputs of the rotation detectors 41 over time at predetermined sampling intervals (e.g. every 10 milliseconds), and stores such outputs in the storage portion 46 as discrete value data 46b including temporally continuous values.

### [Operation of Assist Device]

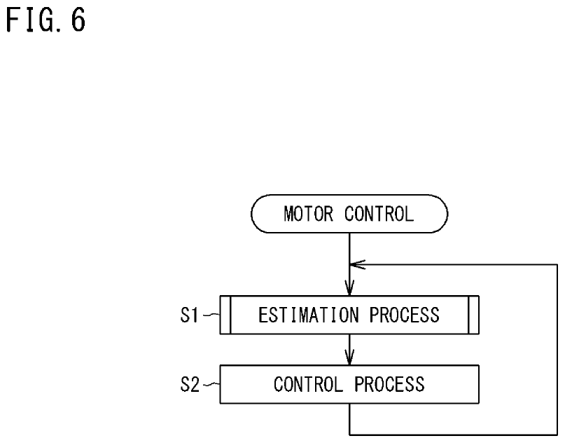

FIG. 6 is a flowchart illustrating a mode of control of the motor 40 performed by the processing portion 45. First, the processing portion 45 performs the estimation process 45b (FIG. 4) (step S1 in FIG. 6). In the estimation process 45b, an estimated weight of a load to be lifted by the user U is obtained. After the estimation process 45b is performed, the processing portion 45 performs the control process 45a (FIG. 4) (step S2 in FIG. 6). In the control process 45a, assist torque is generated by controlling the motor 40 based on the estimated weight. The processing portion 45 generates assist torque when an estimated weight is obtained through the estimation process 45b. In this manner, the processing portion 45 first performs the estimation process 45b before controlling the motor 40.

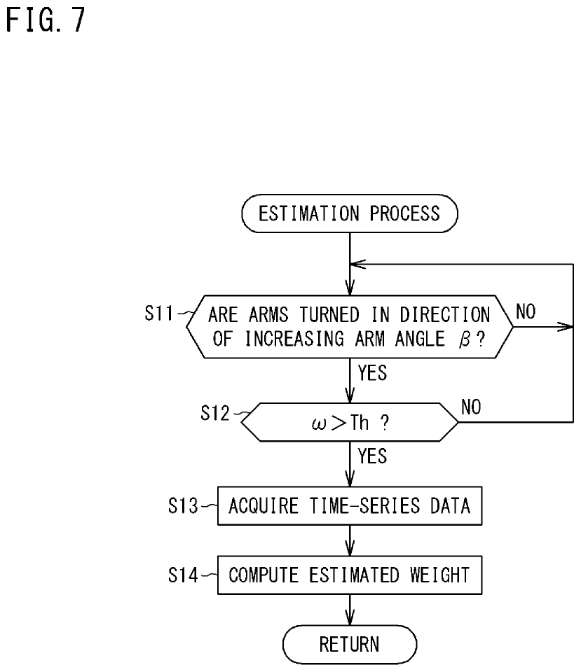

FIG. 7 is a flowchart illustrating an example of the estimation process. First, the processing portion 45 executes the determination process 45b2 (FIG. 4), and determines whether the outputs of the rotation detectors 41 meet a predetermined condition (steps S11 and S12 in FIG. 7). More specifically, the predetermined condition is met when the arm angular velocity ω becomes more than a threshold Th set in advance when the assist arms 13 are turned in a direction in which the hip joints of the user U are extended from a bent state. That is, the predetermined condition is met when the arm angular velocity ω becomes more than the threshold Th set in advance when the assist arms 13 are turned in the direction of increasing the arm angle β.

Hence, the processing portion 45 determines whether the assist arms 13 are turned in the direction of increasing the arm angle β (step S11 in FIG. 7). The processing portion 45 also obtains information that indicates the turning direction of the assist arms 13 when obtaining the arm angular velocity ω. The processing portion 45 determines whether the assist arms 13 are turned in the direction of increasing the arm angle ω based on the information that indicates the turning direction of the assist arms 13 acquired when obtaining the arm angular velocity ω. The processing portion 45 repeatedly performs step S11 until it is determined that the assist arms 13 are turned in the direction of increasing the arm angle β.

When it is determined that the assist arms 13 are turned in the direction of increasing the arm angle β, the processing portion 45 determines whether the arm angular velocity ω obtained most recently is more than the threshold Th (step S12 in FIG. 7). When it is determined that the arm angular velocity ω is not more than the threshold Th (is equal to or less than the threshold Th), the processing portion 45 returns to step S11 again. In this manner, the processing portion 45 determines whether the arm angular velocity ω is more than the threshold Th (steps S11 and S12 in FIG. 7) when the assist arms 13 are turned in the direction of increasing the arm angle β by executing the determination process 45b2.

When it is determined in step S12 that the arm angular velocity ω is more than the threshold Th, the processing portion 45 acquires first time-series data and second time-series data (step S13 in FIG. 7).

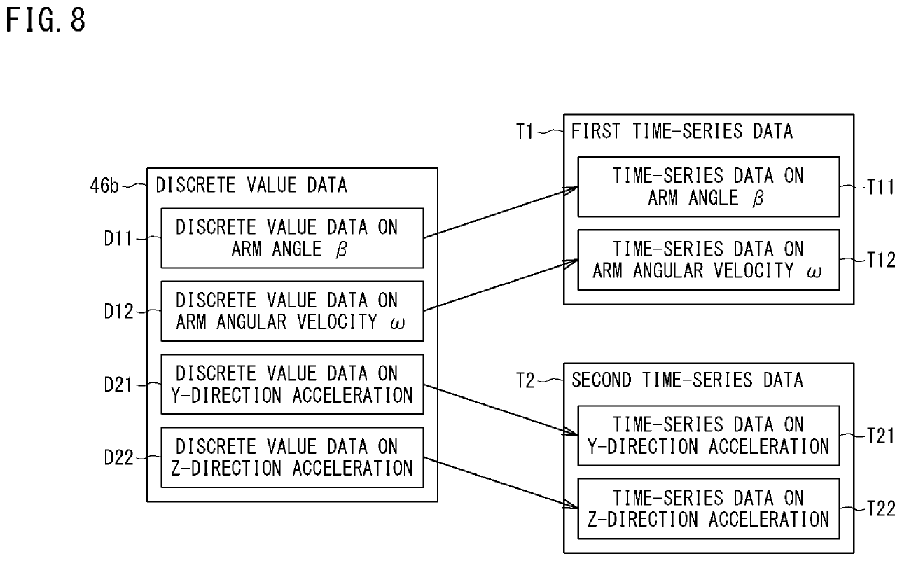

The first time-series data and the second time-series data are acquired from among the discrete value data 46b stored in the storage portion 46. FIG. 8 illustrates the content of the first time-series data and the second time-series data acquired from the discrete value data 46b.

In FIG. 8, first time-series data T1 are time-series data based on a plurality of outputs of the rotation detectors 41 acquired during a previous period P. The previous period P is a period until the time when the arm angular velocity ω (outputs of the rotation detectors 41) that is used for the determinations in steps S11 and S12 is acquired since the time a predetermined time earlier. The first time-series data T1 include time-series data T11 on the arm angle β and time-series data T12 on the arm angular velocity ω.

The first time-series data T1 are acquired from among the discrete value data 46b stored in the storage portion 46. The discrete value data 46b include discrete value data D11 on the arm angle β and discrete value data D12 on the arm angular velocity ω. The discrete value data D11 on the arm angle β include a plurality of temporally continuous values of the arm angle β. Meanwhile, the discrete value data D12 on the arm angular velocity ω include a plurality of temporally continuous values of the arm angular velocity ω. The processing portion 45 acquires a plurality of arm angles β acquired during the previous period P from among the discrete value data D11 on the arm angle β as the time-series data T11 on the arm angle β. Hence, the time-series data T11 on the arm angle β include a plurality of arm angles β acquired during the previous period P as a plurality of elements. Meanwhile, the processing portion 45 acquires a plurality of arm angular velocities ω acquired during the previous period P from among the discrete value data D12 on the arm angular velocity ω as the time-series data T12 on the arm angular velocity ω. Hence, the time-series data T12 on the arm angular velocity ω include a plurality of arm angular velocities ω acquired during the previous period P as a plurality of elements. Consequently, the processing portion 45 acquires the first time-series data T1. The processing portion 45 acquires a plurality of arm angles β acquired during the previous period P and a plurality of arm angular velocities ω acquired during the previous period P for each of the right and left assist arms 13. Hence, the time-series data T11 on the arm angle β and the time-series data T12 on the arm angular velocity ω include data for each of the right and left assist arms 13.

The second time-series data T2 are time-series data based on a plurality of outputs of the acceleration sensor 15 acquired during the previous period P discussed above. The second time-series data T2 include time-series data T21 on the Y-direction acceleration and time-series data T22 on the Z-direction acceleration.

The second time-series data T2 are also acquired from among the discrete value data 46b stored in the storage portion 46. The discrete value data 46b include discrete value data D21 on the Y-direction acceleration and discrete value data D22 on the Z-direction acceleration. The discrete value data D21 on the Y-direction acceleration include a plurality of temporally continuous values of the Y-direction acceleration. Meanwhile, the discrete value data D22 on the Z-direction acceleration include a plurality of temporally continuous values of the Z-direction acceleration. The processing portion 45 acquires a plurality of Y-direction accelerations acquired during the previous period P from among the discrete value data D21 on the Y-direction acceleration as the time-series data T21 on the Y-direction acceleration. Hence, the time-series data T21 on the Y-direction acceleration include a plurality of Y-direction accelerations acquired during the previous period P as a plurality of elements. Meanwhile, the processing portion 45 acquires a plurality of Z-direction accelerations acquired during the previous period P from among the discrete value data D22 on the Z-direction acceleration as the time-series data T22 on the Z-direction acceleration. Hence, the time-series data T22 on the Z-direction acceleration include a plurality of Z-direction accelerations acquired during the previous period P as a plurality of elements. Consequently, the processing portion 45 acquires the second time-series data T2.

Then, the processing portion 45 executes the weight estimation process 45b3 (FIG. 4), and obtains an estimated weight of a load to be lifted by the user U based on the first time-series data T1 and the second time-series data T2 (step S14 in FIG. 7). The processing portion 45 obtains an estimated weight using the trained model 46a (FIG. 4) stored in the storage portion 46. The trained model 46a is a model obtained through machine learning of the relationship between the first time-series data T1 and the second time-series data T2 and the weight of the load. That is, the trained model 46a is a model that has the first time-series data T1 and the second time-series data T2 as an explanatory variable and the weight of the load as an objective variable.

There is a correlation between the outputs of the rotation detectors 41 and the output of the acceleration sensor 15 immediately after the user U has started lifting a load and the weight of the load lifted by the user U. The trained model 46a is built based on this correlation.

Hence, the processing portion 45 needs to acquire the first time-series data T1 based on the outputs of the rotation detectors 41 and the second time-series data T2 based on the acceleration sensor 15 immediately after the user U has started lifting a load.

The outputs of the rotation detectors 41 indicate the turning state of the thigh portions BF with respect to the waist portion BW. Hence, the processing portion 45 can acquire the first time-series data T1 and the second time-series data T2 immediately after the user U has started lifting a load by determining the predetermined condition (steps S11 and S12 in FIG. 7) such that the determination process 45b2 is performed immediately after the thigh portions BF have started turning.

In the present embodiment, the predetermined condition is determined so as to be met when the arm angular velocity ω becomes more than the threshold Th set in advance (step S12 in FIG. 7) when the assist arms 13 are turned in the direction of increasing the arm angle β (step S11 in FIG. 7). Thus, the processing portion 45 can determine the start of turning of the thigh portions BF in accordance with the threshold Th. As a result, the processing portion 45 can appropriately acquire the first time-series data T1 and the second time-series data T2 immediately after the user U has started lifting a load.

Teacher data that are used for machine learning of the trained model 46a include the first time-series data T1 and the second time-series data T2 obtained when the user U has performed operation to lift a load with a known weight. The teacher data are acquired by the user U using the assist device 10. The trained model 46a has been subjected to machine learning in advance using the acquired teacher data. The algorithm of the machine learning may be either a classification algorithm or a regression algorithm. Examples include SVC (Support Vector Classification) and SVR (Support Vector Regression). However, these are not limiting, and a neural network, a decision tree, a random forest, etc. may also be used.

The processing portion 45 obtains an estimated weight by providing the first time-series data T1 and the second time-series data T2 acquired in step S13 to the trained model 46a. When an estimated weight is obtained, the processing portion 45 returns to FIG. 6, and performs the control process 45a (FIG. 4) and controls the motor 40 based on the estimated weight.

The assist device 10 configured as described above executes the estimation process 45b (FIG. 4) of obtaining an estimated weight of a load to be lifted by the user U based on the output of the acceleration sensor 15 and the outputs of the rotation detectors 41. Thus, torque (assist torque) can be controlled in accordance with the weight of the load without providing a dedicated sensor for detecting the weight of the load. As a result, the cost of the assist device 10 can be reduced, and the user U can wear the assist device 10 easily without the need for the user U to wear components other than the first wearing tool 11 and the second wearing tools 12.

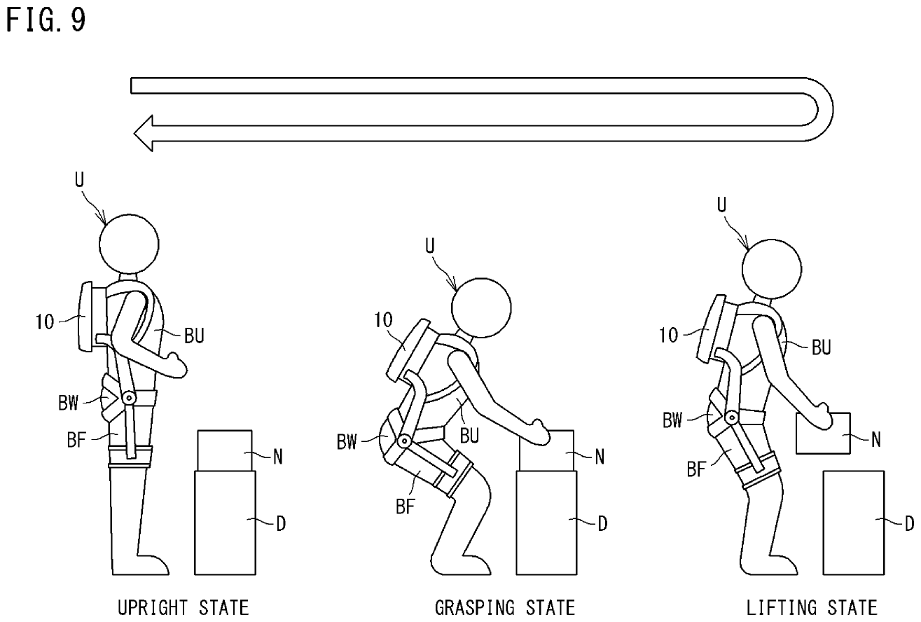

Here, the estimation process 45b performed by the assist device 10 when the user U continuously performs operation to lift the load N in front of the user U and operation to lower the load as illustrated in FIG. 9 will be described.

FIG. 9 illustrates three states including an upright state, a grasping state, and a lifting state as the state of the user U. In the upright state, the user U is in the upright posture. In the upright state, the upper body BU and the thigh portions BF are substantially parallel to the vertical direction. In the grasping state, the user U is in the squatting posture, and is grasping the load N disposed on the loading platform D disposed in front of the user U. In the grasping state, the user U is not lifting the load N. In addition, the hip joints and the knee joints of the user U are bent with the upper body BU inclined forward and with the thigh portions BF inclined rearward. In the lifting state, the user U is in the squatting posture, and is lifting the grasped load N from the loading platform D. The hip joints and the knee joints of the user U are bent with the upper body BU inclined forward and with the thigh portions BF inclined rearward. The height of the waist portion BW of the user U in the lifting state is higher than the height of the waist portion BW in the grasping state.

Here, it is assumed that the operation of the user U to lift the load N is performed by transitioning from the upright state to the lifting state by way of the grasping state. In addition, it is assumed that the operation of the user U to lower the load N is performed by transitioning from the lifting state to the upright state by way of the grasping state. In addition, it is assumed that the user U performs the lifting operation and the load lowering operation by moving the right and left legs including the thigh portions BF in the same manner. While FIG. 9 indicates that the user grasps and lifts the load by taking the squatting posture, the estimation process 45b can similarly be performed also when the load is grasped and lifted by taking a posture in which only the waist portion is bent without bending the knee joints.

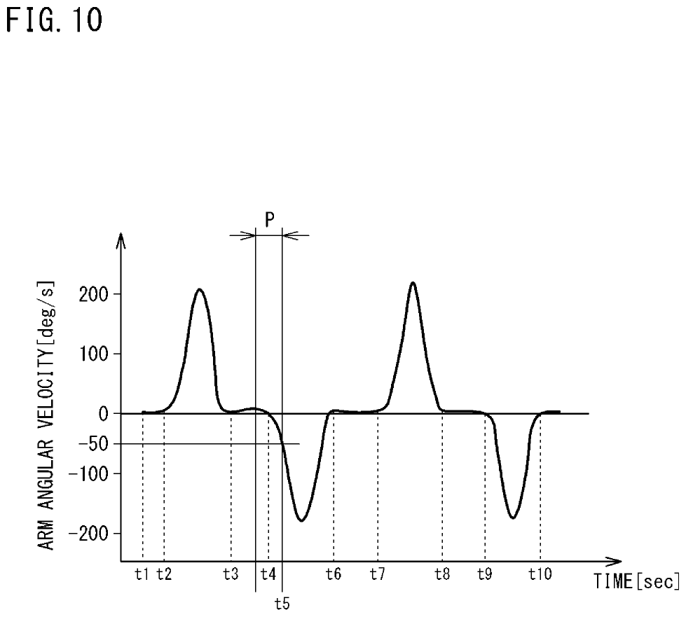

FIG. 10 is a graph indicating an example of the arm angular velocity ω at the time when the user U continuously performs the operation to lift the load N and the operation to lower the load. In FIG. 10, the horizontal axis indicates the time, and the vertical axis indicates the arm angular velocity ω. In FIG. 10, the arm angular velocity ω at the time when the assist arms 13 are turned in the direction of increasing the arm angle β is indicated as a negative value, and the arm angular velocity ω at the time when the assist arms 13 are turned in the direction of decreasing the arm angle β is indicated as a positive value. The arm angular velocity ω indicated as a negative value in FIG. 10 indicates the arm angular velocity ω at the time when the assist arms 13 are turned in the direction of increasing the arm angle β, and does not indicate that the arm angular velocity ω has a negative numerical value. When the arm angular velocity ω indicates −50 degrees/second in FIG. 10, it is indicated that the arm angular velocity ω at the time when the assist arms 13 are turned in the direction of increasing the arm angle β is 50 degrees/second.

In FIG. 10, since timing t1 until timing t2, the arm angular velocity ω is substantially 0, and the user U is in the upright state. Since timing t2 until timing t3, the assist arms 13 are turned in the direction of decreasing the arm angle β. That is, the user U varies the posture from the upright state (upright posture) to the grasping state (squatting posture) by bending the hip joints since timing t2 until timing t3.

Since timing t3 until timing 14, the arm angular velocity ω is substantially 0, and the user U maintains the grasping state.

Since timing 14 until timing 16, the assist arms 13 are turned in the direction of increasing the arm angle β. That is, the user U performs lifting operation by varying the posture from the grasping state (squatting posture) to the lifting state (squatting posture) by extending the hip joints since timing 14 until timing t6.

Since timing t6 until timing t7, the arm angular velocity ω is substantially 0, and the user U maintains the lifting state.

Since timing 17 until timing 18, the assist arms 13 are turned in the direction of decreasing the arm angle β. That is, the user U performs load lowering operation by varying the posture from the lifting state (squatting posture) to the grasping state (squatting posture) by bending the hip joints since timing t7 until timing t8.

Since timing 18 until timing 19, the arm angular velocity ω is substantially 0, and the user U maintains the grasping state.

Since timing 19 until timing t10, the assist arms 13 are turned in the direction of increasing the arm angle β. That is, the user U varies the posture from the grasping state (squatting posture) to the upright state (upright posture) by extending the hip joints since timing 19 until timing t10.

Here, it is assumed that the threshold Th in step S11 in FIG. 7 is 50 degrees/second. In this case, since timing t4 until timing t6 in FIG. 10, the assist arms 13 are turned in the direction of increasing the arm angle β. That is, the user U performs lifting operation by varying the posture from the grasping state (squatting posture) to the lifting state (squatting posture) by extending the hip joints since timing t4 until timing t6.

In FIG. 10, the arm angular velocity ω is increased along with the lapse of time since timing t4, and reaches 50 degrees/second as the threshold Th at timing t5. Hence, the arm angular velocity ω becomes more than the threshold Th when timing t5 is exceeded. In this case, the arm angular velocity ω at the time when the assist arms 13 are turned in the direction of increasing the arm angle β becomes more than the threshold Th. Hence, when timing t5 is passed, the processing portion 45 determines that the arm angular velocity ω is more than the threshold Th (step S12 in FIG. 7), executes the weight estimation process 45b3 (FIG. 4), and acquires the first time-series data T1 and the second time-series data T2 (step S13 in FIG. 7).

Here, a mode in which the processing portion 45 acquires the time-series data T12 on the arm angular velocity ω included in the first time-series data T1 will be described. As discussed above, the processing portion 45 acquires a plurality of values of the arm angular velocity ω acquired during the previous period P from among the discrete value data D12 on the arm angular velocity ω as the time-series data T12 on the arm angular velocity ω. The previous period P is a period until the time when (an output of the rotation detector 41 that obtained) the arm angular velocity ω determined to be more than the threshold Th was acquired since the time a predetermined time earlier. In the present embodiment, it is assumed that the duration of the previous period P is 500 milliseconds. The processing portion 45 acquires a plurality of values of the arm angular velocity ω included in the previous period P until timing 15 since 500 milliseconds earlier as the time-series data T12 on the arm angular velocity ω.

While FIG. 10 illustrates a mode in which the processing portion 45 acquires the time-series data T12 on the arm angular velocity ω, a mode in which the time-series data T11 on the arm angle β are acquired is also similar to the mode in which the time-series data T12 on the arm angular velocity ω are acquired. The processing portion 45 acquires a plurality of arm angles β included in the previous period P as the time-series data on the arm angle β.

In addition, a mode in which the time-series data T21 on the Y-direction acceleration and the time-series data T22 on the Z-axis direction acceleration are acquired is also similar to the mode in which the time-series data T12 on the arm angular velocity wo are acquired. The processing portion 45 acquires a plurality of accelerations in the Y direction included in the previous period P as the time-series data T21 on the Y-direction acceleration, and acquires a plurality of accelerations in the Z direction included in the previous period P as the time-series data T22 on the Z-direction acceleration. Consequently, the processing portion 45 acquires the first time-series data T1 and the second time-series data T2.

When the first time-series data T1 and the second time-series data T2 are acquired, the processing portion 45 obtains an estimated weight (step S14 in FIG. 7). Further, the processing portion 45 performs the control process 45a, and generates assist torque by controlling the motor 40 based on the estimated weight (step S2 in FIG. 6).

In FIG. 10, also since timing 19 until timing t10, the arm angular velocity ω at the time when the assist arms 13 are turned in the direction of increasing the arm angle β becomes more than the threshold Th. Hence, the processing portion 45 acquires the first time-series data T1 and the second time-series data T2 by executing the weight estimation process 45b3 (FIG. 4) since timing 19 until timing 110. In this case, the user U is not holding the load N. and thus the estimated weight obtained through the estimation process 45b is a value obtained with the user U not holding the load N. The processing portion 45 generates assist torque based on the estimated weight obtained with the user U not holding the load N, and thus can perform control such that assist torque more than necessary is not provided to the user U.

### [Previous Period]

As discussed above, the processing portion 45 needs to acquire the first time-series data T1 based on the outputs of the rotation detectors 41 and the second time-series data T2 based on the acceleration sensor 15 immediately after the user U has started lifting a load.

In the present embodiment, the start of turning of the thigh portions BF is detected in accordance with the threshold Th, and the first time-series data T1 and the second time-series data T2 are obtained based on the outputs of the rotation detectors 41 and the output of the acceleration sensor 15 acquired in the previous period P since a predetermined time earlier. Consequently, the first time-series data T1 based on the outputs of the rotation detectors 41 and the second time-series data T2 based on the acceleration sensor 15 immediately after the user U has started lifting a load are acquired. Therefore, it is necessary to appropriately set the previous period P (FIG. 10).

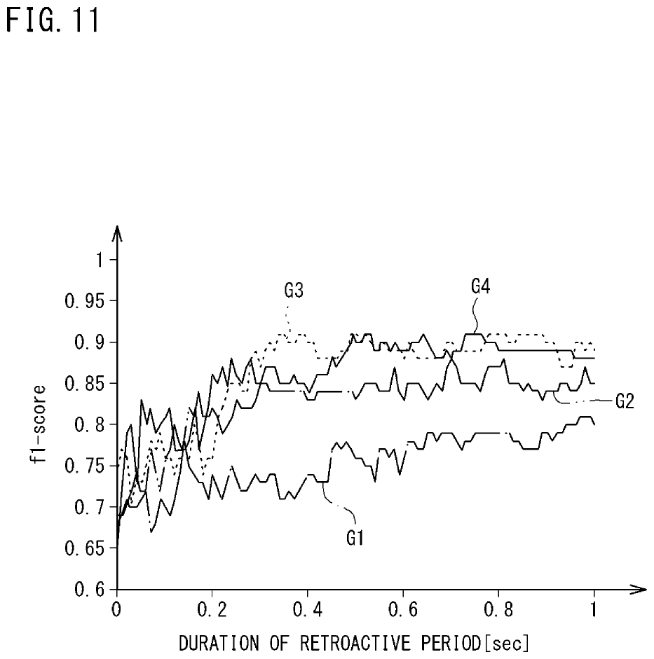

The previous period P is determined by the threshold Th and the duration of the previous period P. FIG. 11 is a graph indicating an example of an f1 score at the time when an estimated weight is obtained by varying the threshold Th and the duration of the previous period P. In FIG. 11, the horizontal axis is the duration (seconds) of the previous period P. and the vertical axis is the f1 score. In FIG. 11, in addition, a graph G1 indicates an f1 score at the time when the threshold Th is 20 degrees/second. A graph G2 indicates an f1 score at the time when the threshold Th is 30 degrees/second. A graph G3 indicates an f1 score at the time when the threshold Th is 40 degrees/second. A graph G4 indicates an f1 score at the time when the threshold Th is 50 degrees/second.

As indicated in FIG. 11, a reduction in precision is observed when the duration of the previous period P is 0.3 seconds or less, and a relatively high precision is obtained when the duration of the previous period P is 0.4 seconds or more. In addition, a reduction in precision is observed when the threshold Th is 30 degrees/second or less, and a relatively high precision is obtained when the threshold Th is in the range from 40 degrees/second to 50 degrees/second. In this manner, it is seen that the precision in estimating an estimated weight can be enhanced by appropriately setting the previous period P.

### [Retraining Process]

The assist device 10 according to the present embodiment has a function to execute a process of receiving teacher data provided externally and a process of retraining the trained model 46a based on the teacher data, by executing the retraining process 45c.

The processing portion 45 makes mode switching from a normal mode to a training mode when the retraining process 45c is performed. In the normal mode, the user U is assisted in working, and the estimation process 45b and the control process 45a discussed above are executed. In the training mode, the trained model 46a is retrained.

In the training mode, the processing portion 45 can receive the teacher data via an input portion (not illustrated) for receiving an external input. In the training mode, in addition, when the user U performs operation to lift a load with a known weight, the processing portion 45 can use the first time-series data T1 and the second time-series data T2 obtained at that time and the weight of the load as the teacher data.

In this manner, the trained model 46a is retrained using the relationship between the first time-series data and the second time-series data during the actual use by the user U and the weight of the load as the teacher data, and thus the trained model 46a can be optimized in accordance with the user U and, further, the precision of the estimated weight can be enhanced.

### Second Embodiment

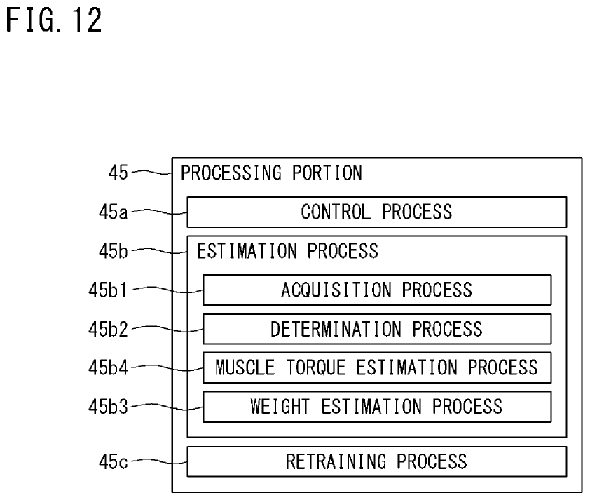

FIG. 12 is a block diagram illustrating the configuration of a processing portion 45 of an assist device 10 according to a second embodiment. The present embodiment is different from the above embodiment in that the processing portion 45 has a function to execute a muscle torque estimation process 45b4. In the muscle torque estimation process 45b4, the processing portion 45 according to the present embodiment obtains estimated muscle torque for turning the thigh portions BF exhibited by the muscle power of the user U based on the inclination angle α (FIG. 5) of the upper body BU of the user U and the angular velocity of the upper body BU obtained from the output of the acceleration sensor 15 and the arm angle β and the arm angular velocity ω obtained from the outputs of the rotation detectors 41. The angular velocity of the upper body BU is obtained based on the increment of the inclination angle α per unit time by acquiring the inclination angle α of the upper body BU over time. The estimated muscle torque is obtained by providing the parameters discussed above to a muscle torque estimation model built in advance.

When the assist arms 13 are turned in the direction of increasing the arm angle β and it is determined that the arm angular velocity ω is more than the threshold Th (steps S11 and S12 in FIG. 7) by executing the determination process 45b2, the processing portion 45 according to the present embodiment acquires time-series data on the estimated muscle torque (step S13 in FIG. 7), and obtains an estimated weight based on the time-series data on the estimated muscle torque (step S14 in FIG. 7).

The time-series data on the estimated muscle torque include a plurality of values of the estimated muscle torque obtained based on a plurality of outputs of the rotation detectors 41 and a plurality of outputs of the acceleration sensor 15 acquired in the previous period P.

The trained model 46a according to the present embodiment is a model obtained through machine learning of the relationship between the time-series data on the estimated muscle torque and the weight of a load. The processing portion 45 obtains an estimated weight by providing the time-series data on the estimated muscle torque to the trained model 46a.

Also in the present embodiment, the estimated weight can be obtained precisely based on the time-series data on the estimated muscle torque obtained in the previous period P.

### Third Embodiment

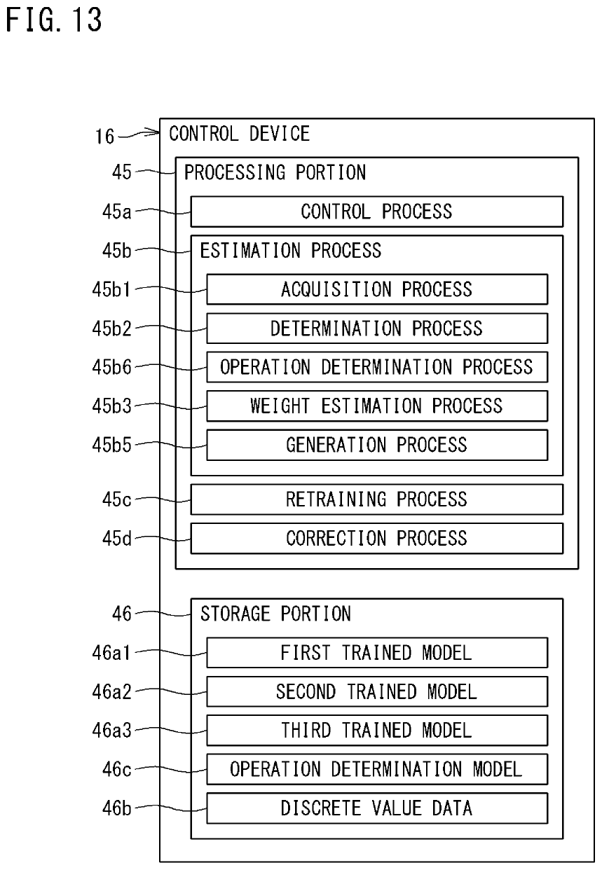

FIG. 13 is a block diagram illustrating an example of the configuration of a control device 16 according to a third embodiment. The present embodiment is different from the first embodiment in that the processing portion 45 further has a function to execute a correction process 45d, and that the estimation process 45b further includes an operation determination process 45b6 and a generation process 45b5. In addition, the storage portion 46 stores a first trained model 46al, a second trained model 46a2, a third trained model 46a3, and an operation determination model 46c.

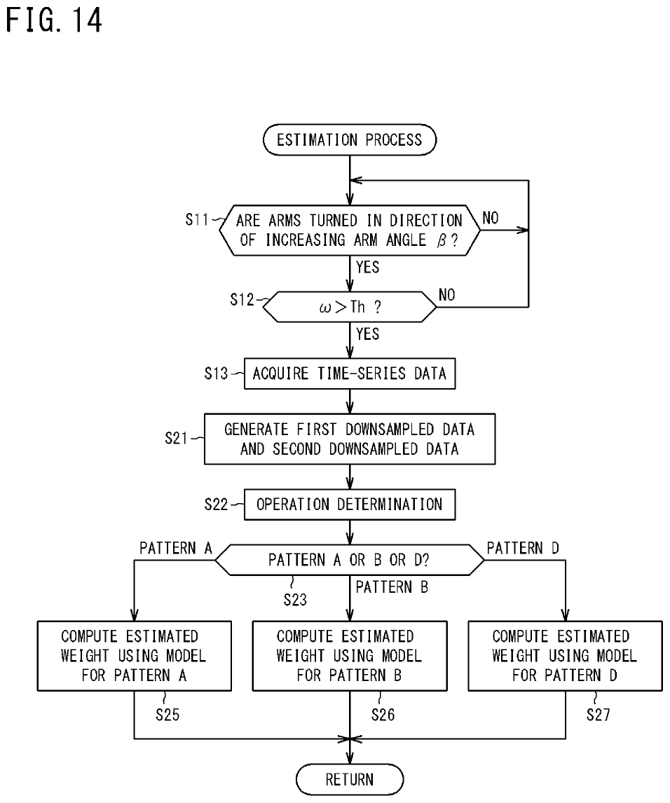

FIG. 14 is a flowchart illustrating an estimation process performed by the processing portion 45 according to the present embodiment. In FIG. 14, steps S11 and S12 are the same as steps S1 and S12 in FIG. 7.

In FIG. 14, the processing portion 45 acquires first time-series data T1 and second time-series data T2 in step S13. The first time-series data T1 according to the present embodiment include average values of values related to the right and left assist arms 13 at the same timings as a plurality of elements. That is, the time-series data T11 on the arm angle β include average values of the arm angle β of the right and left assist arms 13 at the same timings as a plurality of elements. Meanwhile, the time-series data T12 on the arm angular velocity ω include average values of the arm angular velocity ω of the right and left assist arms 13 at the same timings as a plurality of elements. The processing portion 45 acquires the first time-series data T1 by acquiring a plurality of arm angles β and arm angular velocities ω acquired during the previous period P from among the discrete value data 46b and obtaining respective average values of the arm angles β and the arm angular velocities ω. In the following description, the average values of the arm angles β will be simply referred to as “arm angles β”, and the average values of the arm angular velocities ω will be simply referred to as “arm angular velocities ω”.

In FIG. 14, when the first time-series data T1 and the second time-series data T2 are acquired in step S13, the processing portion 45 executes the generation process 45b5. In the generation process 45b5, the processing portion 45 generates first downsampled data and second downsampled data (step S21 in FIG. 14).

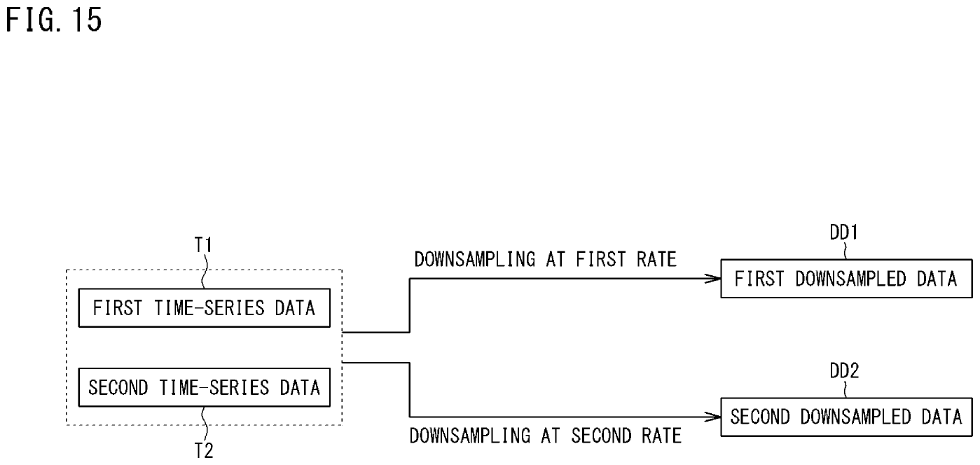

FIG. 15 illustrates a mode in which the first downsampled data and the second downsampled data are generated from the first time-series data and the second time-series data. As illustrated in FIG. 15, the processing portion 45 generates first downsampled data DD1 by downsampling the first time-series data T1 and the second time-series data T2 at a first sampling rate set in advance. In addition, the processing portion 45 generates second downsampled data DD2 by downsampling the first time-series data T1 and the second time-series data T2 at a second sampling rate set in advance.

The first downsampled data DD1 and the second downsampled data DD2 each include data obtained by downsampling the time-series data on the arm angle β, data obtained by downsampling the time-series data on the arm angular velocity wo, data obtained by downsampling the time-series data on the Y-direction acceleration, and data obtained by downsampling the time-series data on the Z-direction acceleration.

In the present embodiment, downsampling is a process of reducing the number of elements included in data by sampling a plurality of elements included in the time-series data T11 on the arm angle β, the time-series data T12 on the arm angular velocity ω, the time-series data T21 on the Y-direction acceleration, and the time-series data T22 on the Z-direction acceleration, included in both the time-series data, at a certain proportion and removing elements other than the sampled elements. The sampling rate is a value that indicates the proportion at which elements included in data before downsampling are sampled. In the present embodiment, the first sampling rate is set to 1/10. The second sampling rate is set to ½.

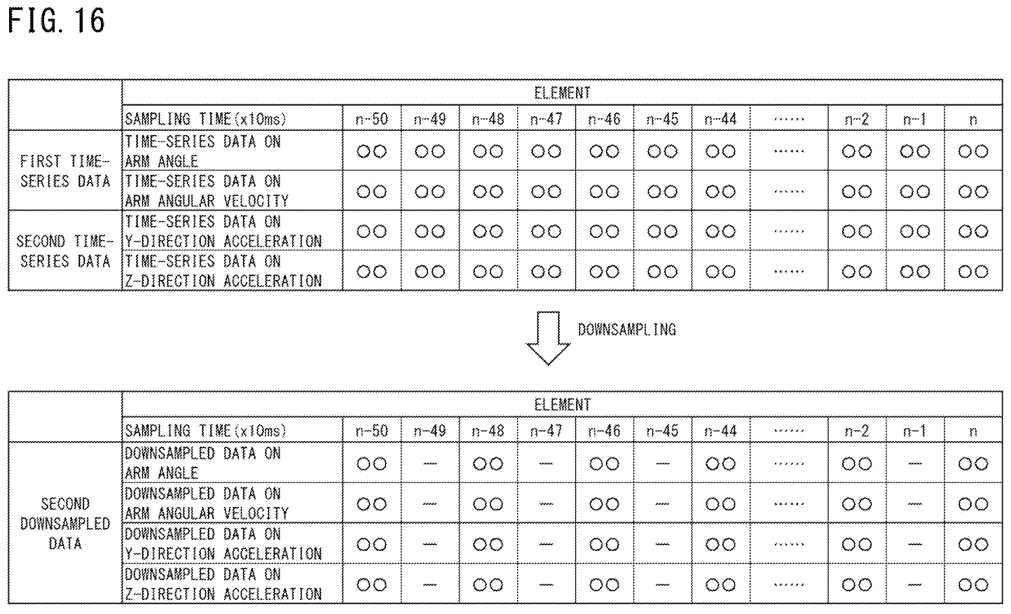

FIG. 16 illustrates downsampling performed by the processing portion 45 according to the present embodiment. The upper part of FIG. 16 indicates the first time-series data T1 and the second time-series data T2. The symbol “∘∘” indicated in the upper part of FIG. 16 indicates an element included in each of the time-series data. For example, when the sampling interval of the discrete value data 46b is 10 milliseconds, the duration of the previous period P is 500 milliseconds, and the time of the end of the previous period P is n (n is an integer corresponding to the time indicated in units of 10 milliseconds), each of the time-series data includes 51 elements corresponding to times at intervals of 10 milliseconds, from time n−50 to time n.

The lower part of FIG. 16 indicates the second downsampled data DD2 obtained by downsampling the time-series data T1 and T2 indicated in the upper part at the second sampling rate. The symbol “-” indicated in the lower part of FIG. 16 indicates that the element at that time has been removed and is not present.

The second downsampled data DD2 include downsampled data on the arm angle β, downsampled data on the arm angular velocity ω, downsampled data on the Y-direction acceleration, and downsampled data on the Z-direction acceleration.

When downsampling is performed at the second sampling rate, the 51 elements included in each of the time-series data are sampled at a proportion of 1 out of 2. Hence, the 51 elements included in each of the time-series data are sampled at a frequency of 20 milliseconds. In the example in the drawing, each of the downsampled data includes 26 elements corresponding to times at intervals of 20 milliseconds, from time n−50 to time n. In this manner, the number of elements included in the second downsampled data DD2 is about half the number of elements included in the time-series data before the downsampling.

When downsampling is performed at the first sampling rate, the 51 elements included in each of the time-series data are sampled at a proportion of 1 out of 10. Hence, the 51 elements included in each of the time-series data are sampled at a frequency of 100 milliseconds. In this case, each of the downsampled data includes 6 elements corresponding to time n−50, time n−40, time n−30, time n−20, time n−10, and time n. In this manner, the number of elements included in the first downsampled data DD1 is about one-tenth the number of elements included in the time-series data before the downsampling.

In this manner, the processing portion 45 reduces the amount of data to be processed later by generating the first downsampled data DD1 and the second downsampled data DD2 by downsampling the first time-series data and the second time-series data.

When the downsampled data DD1 and DD2 are generated in step S21 in FIG. 14, the processing portion 45 executes the operation determination process 45b6 (FIG. 13) (step S22 in FIG. 14). In the operation determination process 45b6, the processing portion 45 determines operation of the user U based on the first downsampled data DD1. The processing portion 45 determines operation of the user U to lift a load.

The processing portion 45 determines operation of the user U using the operation determination model 46c (FIG. 13) stored in the storage portion 46. The operation determination model 46c is a model obtained through machine learning of the relationship between the first downsampled data and a plurality of operation patterns set in advance.

In the present embodiment, three operation patterns (operation pattern A, operation pattern B, and operation pattern D) are set as operation patterns taken when the user U lifts the load N. As illustrated in FIG. 9, each of the three operation patterns includes the upright state, the grasping state, and the lifting state as the state of the user U. Each of the three operation patterns is obtained by patterning operation of the user U performed when the user lifts and lowers the load N by sequentially varying the state of the user U.

Of the three operation patterns, the operation pattern A is the same as operation to lift the load N according to the first embodiment. That is, the operation pattern A is a pattern in which the user U lifts the load N disposed on the loading platform D with both hands while squatting as illustrated in FIG. 9. In the grasping state in the operation pattern A, the user U takes a squatting posture by bending the knee joints, and grasps the load N on the loading platform D with both hands.

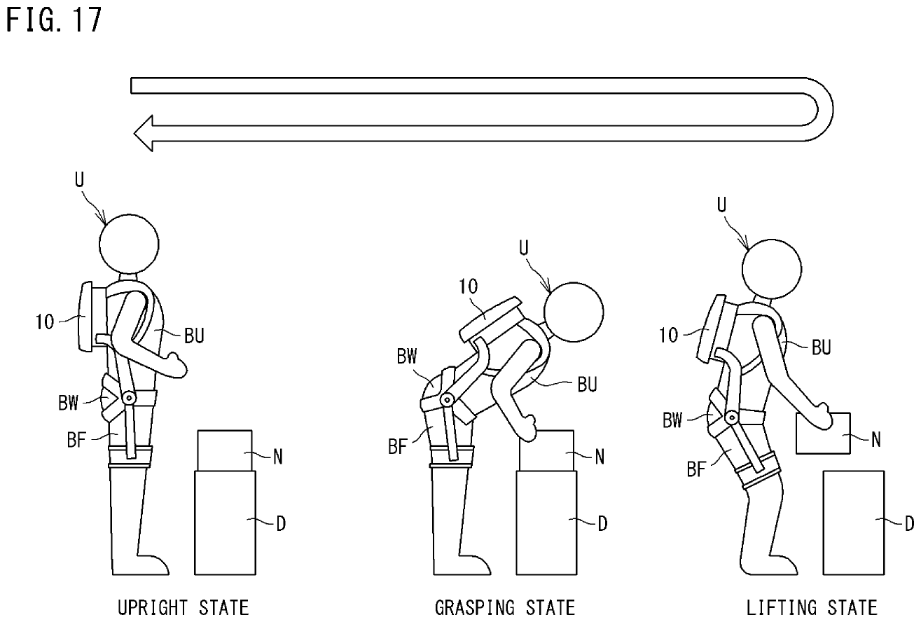

FIG. 17 illustrates the operation pattern B taken when the user U lifts the load N. The operation pattern B is a pattern in which the user U lifts the load N disposed on the loading platform D with both hands by bending the waist without bending the knees as illustrated in FIG. 17. In the grasping state in the operation pattern B, the upper body BU of the user U is inclined forward by bending the hip joints and the waist portion BW with the knee joints hardly bent. The user U in the grasping state grasps the load N on the loading platform D with both hands. The lifting state in the operation pattern B is substantially the same as the lifting state in the operation pattern A.

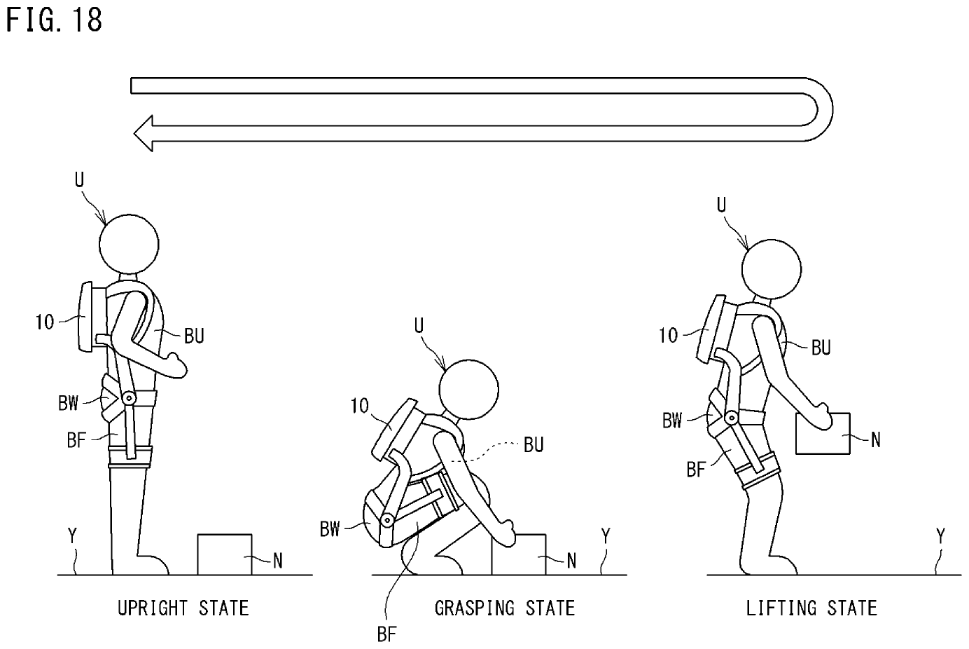

FIG. 18 illustrates an operation pattern D at the time when the user U lifts a load N. The operation pattern D is a pattern in which the user U lifts the load N disposed on a floor surface Y with both hands while squatting as illustrated in FIG. 18. In the grasping state in the operation pattern D, as in the operation pattern A, the hip joints and the knee joints of the user U are bent with the upper body BU inclined forward and with the thigh portions BF inclined rearward. In the operation pattern D, the load N is disposed on the floor surface Y. and therefore the upper body BU is inclined forward to a greater degree than in the operation pattern A. The lifting state in the operation pattern D is substantially the same as the lifting state in the operation pattern A.

The operation determination model 46c (FIG. 13) is a model obtained through machine learning of the relationship between the first downsampled data (first time-series data T1 and second time-series data T2) and the three operation patterns discussed above. That is, the operation determination model 46c is a model that has the first downsampled data as an explanatory variable and the operation pattern as an objective variable. There is a correlation between the outputs of the rotation detectors 41 and the output of the acceleration sensor 15 immediately after the user U has started lifting a load and the operation of the user U to lift the load. The operation determination model 46c is built based on this correlation.

Teacher data that are used for machine learning of the operation determination model 46c include the first time-series data T1 and the second time-series data T2 obtained when the user U has performed operation to lift a load in each of the three operation patterns. The teacher data for the operation determination model 46c are acquired by the user U performing load lifting operation in each of the three operation patterns. The operation determination model 46c has been subjected to machine learning in advance using the teacher data. The algorithm of the machine learning may be either a classification algorithm or a regression algorithm. Examples include SVC (Support Vector Classification) and SVR (Support Vector Regression). However, these are not limiting, and a neural network, a decision tree, a random forest, etc. may also be used.

The processing portion 45 provides the first downsampled data to the operation determination model 46c, and determines which of the three operation patterns the operation of the user U corresponds to (step S22 in FIG. 14).

When the first downsampled data are generated, the processing portion 45 determines operation of the user U based on the first downsampled data DD1 (step S22 in FIG. 14).

Then, the processing portion 45 proceeds to step S23, and executes the weight estimation process 45b3 (FIG. 13). In the weight estimation process 45b3, the processing portion 45 obtains an estimated weight of a load to be lifted by the user U based on the determination result of the operation determination and the second downsampled data DD2. In step S23, the processing portion 45 switches the process of obtaining an estimated weight in accordance with the determination result of the operation determination.

When the determination result of the operation determination is the operation pattern A, the processing portion 45 proceeds to step S25 in FIG. 14. In step S25, the processing portion 45 obtains an estimated weight using the first trained model 46a1 (FIG. 13) stored in the storage portion 46. The processing portion 45 obtains an estimated weight by providing the second downsampled data DD2 to the first trained model 46a1. When the determination result of the operation determination is the operation pattern B, the processing portion 45 proceeds to step S26 in FIG. 14. In step S26, the processing portion 45 obtains an estimated weight using the second trained model 46a2 (FIG. 13) stored in the storage portion 46. The processing portion 45 obtains an estimated weight by providing the second downsampled data DD2 to the second trained model 46a2. When the determination result of the operation determination is the operation pattern D, the processing portion 45 proceeds to step S27 in FIG. 14. In step S27, the processing portion 45 obtains an estimated weight using the third trained model 46a3 (FIG. 13) stored in the storage portion 46. The processing portion 45 obtains an estimated weight by providing the second downsampled data DD2 to the third trained model 46a3.

The first trained model 46al is a model for the operation pattern A. That is, the first trained model 46al is a model obtained through machine learning of the relationship between the first time-series data T1 and the second time-series data T2 and the weight of the load N at the time when the user U lifts the load N through operation along the operation pattern A.

The second trained model 46a2 is a model for the operation pattern B. That is, the second trained model 46a2 is a model obtained through machine learning of the relationship between the first time-series data T1 and the second time-series data T2 and the weight of the load N at the time when the user U lifts the load N through operation along the operation pattern B.

The third trained model 46a3 is a model for the operation pattern D. That is, the third trained model 46a3 is a model obtained through machine learning of the relationship between the first time-series data T1 and the second time-series data T2 and the weight of the load N at the time when the user U lifts the load N through operation along the operation pattern D.

The trained models 46a1, 46a2, and 46a3 have been subjected to machine learning in advance by the same method as the trained model 46a according to the first embodiment. The processing portion 45 selects a trained model to be used in accordance with the operation pattern, provides the second downsampled data DD2 to the selected trained model, obtains an estimated weight, and ends the estimation process.

In other words, it is determined in the operation determination process 45b6 which of a plurality of operation patterns set in advance the operation of the user U to lift the load N corresponds to, and an estimated weight is obtained by selectively using a plurality of trained models trained with the relationship between the first time-series data T1 and the second time-series data T2 and the weight of the load for each of the plurality of operation patterns in the weight estimation process 45b3.

As a result, a trained model that matches the operation pattern of the user U can be used, and the precision in estimating an estimated weight can be further enhanced.

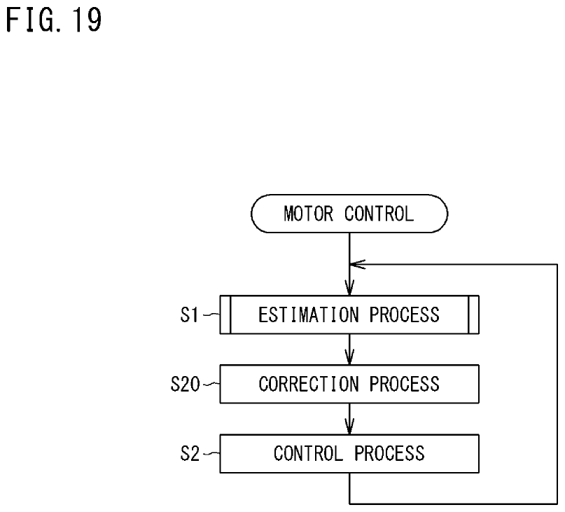

FIG. 19 is a flowchart illustrating a mode of control of a motor 40 performed by the processing portion 45 according to the present embodiment. When the estimation process 45b (FIG. 13) is ended (step S1 in FIG. 19), the processing portion 45 performs the correction process 45d (FIG. 13) (step S20 in FIG. 19). In the correction process 45d, the estimated weight obtained through the estimation process 45b (FIG. 13) is corrected.

The processing portion 45 corrects the estimated weight using sigmoid functions. For example, the processing portion 45 obtains a corrected weight from the estimated weight using sigmoid functions indicated by the following formula (1).

Corrected weight=20/(1+exp(ax−b)) (1)

In the formula (1), x is the estimated weight. The formula indicates a case where the estimated weight is obtained in the range of 0 to 20 kg. In the formula (1), a parameter a and a parameter b are set by fitting the formula for each of the operation patterns A, B, and D of the user U determined when obtaining the estimated weight. Hence, three parameter sets including the parameter a and the parameter b are prepared in correspondence with the three operation patterns. In other words, three formulas (1) are prepared in correspondence with the three operation patterns. The formula (1) and the three parameter sets are stored in the storage portion 46.

The processing portion 45 corrects the estimated weight by selecting one of the three parameter sets in accordance with the operation pattern of the user U obtained through the operation determination process 45b6 and applying the parameter set to the formula (1).

Then, the processing portion 45 performs the control process 45a (step S2 in FIG. 19). The processing portion 45 generates assist torque by controlling the motor 40 based on the corrected weight obtained through the correction process 45d. That is, the processing portion 45 uses the corrected weight as the estimated weight.

In this manner, in the present embodiment, the processing portion 45 is configured to further execute the correction process 45d of correcting the estimated weight obtained through the estimation process 45b using a plurality of sigmoid functions (formula (1)) corresponding to a plurality of operation patterns, and use the corrected weight obtained through the correction process 45d as the estimated weight in the control process 45a. In this case, the estimated weight can be corrected nonlinearly from a minimum value (0 kg) to a maximum value (20 kg). More specifically, the estimated weight is corrected so as to approach the minimum value when the estimated weight is a value that is closer to the minimum value, and corrected so as to approach the maximum value when the estimated weight is a value that is closer to the maximum value. Consequently, the assist torque can be adjusted to a value that is appropriate for the user U.

In the present embodiment, the estimation process 45b includes the operation determination process 45b6, besides the acquisition process 45b1, the determination process 45b2, and the weight estimation process 45b3. In the operation determination process 45b6, operation of the user U to lift a load is determined based on the first time-series data T1 and the second time-series data T2 acquired in the previous period P when it is determined that the outputs of the rotation detectors 41 meet a predetermined condition. In this case, an estimated weight is obtained based on the determination result of the operation determination for the user U, and thus the precision in estimating an estimated weight can be enhanced better.

In the present embodiment, in addition, the estimation process 45b includes the generation process 45b5. In the generation process 45b5, the first downsampled data DD1 are generated by downsampling the first time-series data T1 and the second time-series data T2 at the first sampling rate, and the second downsampled data DD2 are generated by downsampling the first time-series data T1 and the second time-series data T2 at the second sampling rate, when it is determined that the outputs of the rotation detectors 41 meet a predetermined condition. In addition, operation determination is performed based on the first downsampled data DD1 in the operation determination process 45b6, and an estimated weight is obtained based on the determination result of the operation determination and the second downsampled data DD2 in the weight estimation process 45b3. Consequently, the amount of data to be processed in the operation determination process 45b6 and the weight estimation process 45b3 can be decreased, and the processing load on the processing portion 45 can be reduced.

### Fourth Embodiment

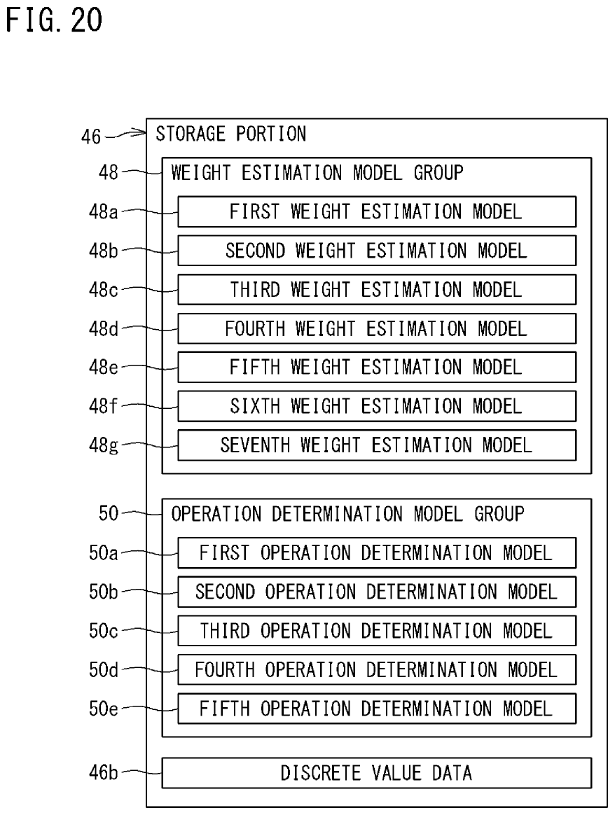

FIG. 20 illustrates a storage portion 46 of a control device 16 according to a fourth embodiment. The present embodiment is different from the third embodiment in that the first time-series data T1 include time-series data on average values of values related to the right and left assist arms 13, time-series data on values related to the right assist arm 13, and time-series data on values related to the left assist arm 13, and that the processing portion 45 that executes the operation determination process 45b6 determines operation of the user U more particularly by selectively using such time-series data.

In the present embodiment, it is determined which of seven types of operation patterns the operation of the user U corresponds to, and an estimated weight is obtained in accordance with the determined operation pattern. As illustrated in FIG. 20, the storage portion 46 stores a weight estimation model group 48 and an operation determination model group 50. The weight estimation model group 48 includes seven models (first weight estimation model 48a, second weight estimation model 48b, third weight estimation model 48c, fourth weight estimation model 48d, fifth weight estimation model 48e, sixth weight estimation model 48f, and seventh weight estimation model 48g) corresponding to the seven types of operation patterns. Meanwhile, the operation determination model group 50 includes five models (first operation determination model 50a, second operation determination model 50b, third operation determination model 50c, fourth operation determination model 50d, and fifth operation determination model 50e).

### [Operation Patterns]

In the present embodiment, seven types of operation patterns (operation pattern A-1, operation pattern A-2, operation pattern B-1, operation pattern B-2, operation pattern C-1, operation pattern C-2, and operation pattern D) are set as discussed above.

The operation pattern A-1 is similar to the operation pattern A according to the second embodiment. That is, the operation pattern A is a pattern in which the user U lifts the load N disposed on the loading platform D with both hands while squatting as illustrated in FIG. 9. In the operation pattern A-2, the user U lifts the load N with one hand in the operation according to the operation pattern A-1.

The operation pattern B-1 is similar to the operation pattern B according to the second embodiment. That is, the operation pattern B-1 is a pattern in which the user U lifts the load N disposed on the loading platform D with both hands with the upper body BU inclined forward by bending the waist without bending the knees as illustrated in FIG. 17. In the operation pattern B-2, the user U lifts the load N with one hand in the operation according to the operation pattern B-1.

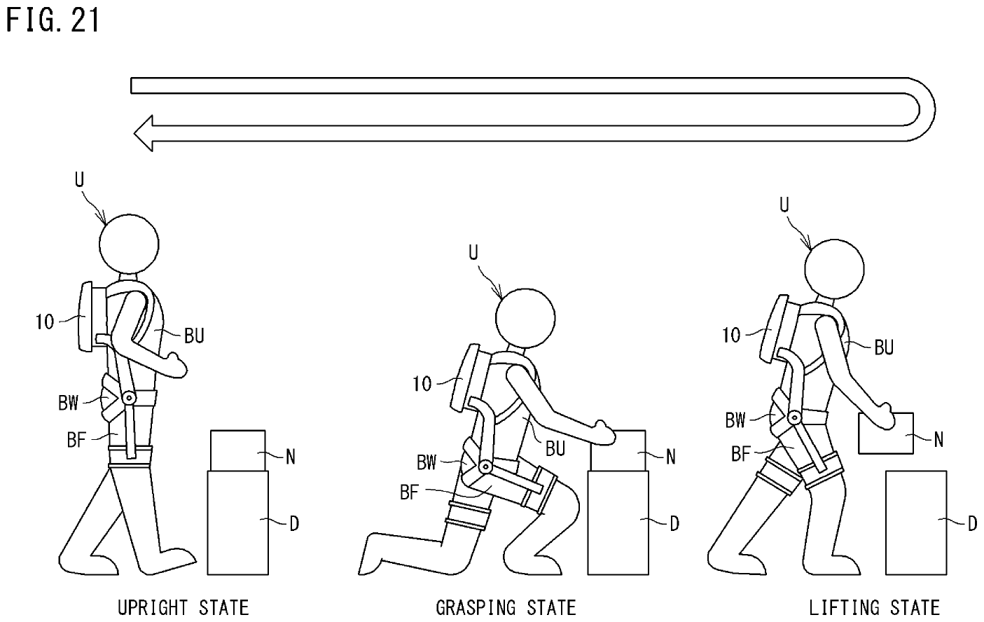

FIG. 21 illustrates the operation pattern C-1 and the operation pattern C-2. The operation pattern C-1 is a pattern in which the user U lifts the load N disposed on the loading platform D with both hands with the upper body BU inclined by standing on one knee as illustrated in FIG. 21. In the grasping state in the operation pattern C-1, one of the knees of the user U is put forward in a bent state while the other knee is drawn rearward. The user U in the grasping state grasps the load N on the loading platform D with both hands. In the lifting state in the operation pattern C-1, a leg of the user U on the other side is drawn rearward of a leg on one side. The operation pattern C-2 is a pattern in which the user U lifts the load N with one hand in the operation according to operation pattern C-1.

The operation pattern D is similar to the operation pattern D according to the second embodiment. That is, the operation pattern D is a pattern in which the user U lifts the load N disposed on the floor surface Y with both hands while squatting as illustrated in FIG. 18.

In the present embodiment, further, the seven types of operation patterns are classified into three groups as indicated below.
Operation group 1: operation pattern A-1 and operation pattern A-2
Operation group 2: operation pattern B-1, operation pattern B-2, operation pattern C-1, and operation pattern C-2
Operation group 3: operation pattern D

The operation group 1 includes patterns in which the user U lifts the load N on the loading platform D while squatting. The operation group 2 includes patterns in which the user U lifts the load N on the loading platform D with the upper body BU inclined forward. The operation group 3 includes patterns in which the user U lifts the load N disposed on the floor surface Y with both hands while squatting.

In the present embodiment, it is first determined which of the three groups the operation of the user U is included in, and further operation determination is performed in the group.

### [Estimation Process]

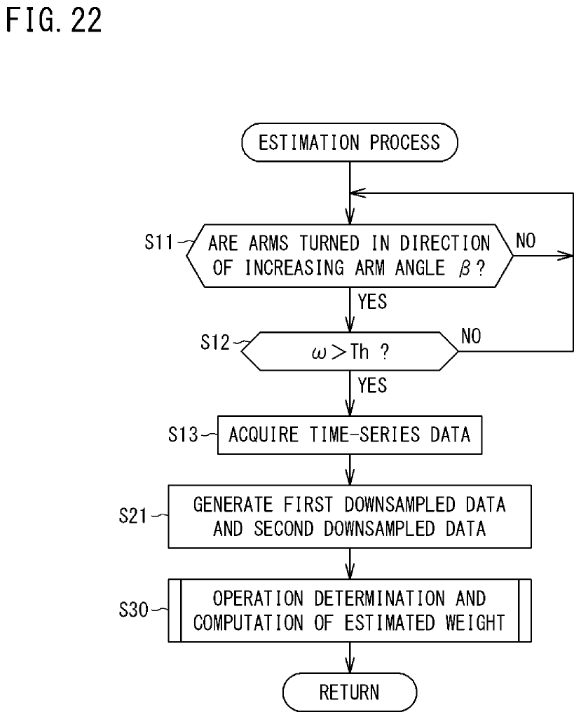

FIG. 22 is a flowchart illustrating an estimation process performed by the processing portion 45 according to the present embodiment. Steps S11 and S12 in FIG. 22 are the same as steps S11 and S12 in FIG. 7.

In FIG. 22, the processing portion 45 acquires first time-series data T1 and second time-series data T2 in step S13. When the first time-series data T1 and the second time-series data T2 are acquired, the processing portion 45 proceeds to step S21, executes the generation process 45b5, and generates first downsampled data and second downsampled data.

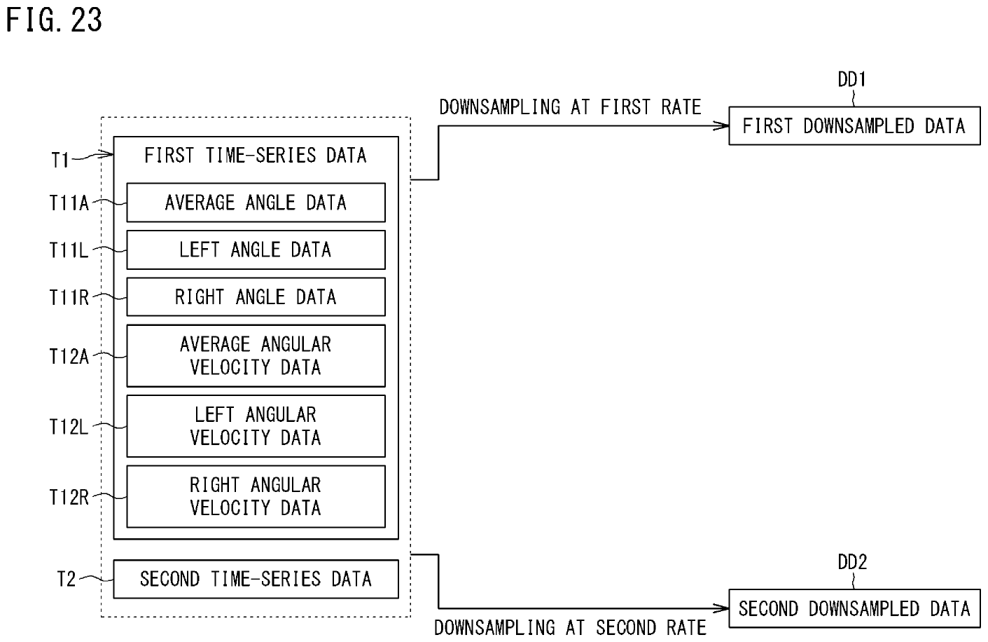

FIG. 23 illustrates a mode in which the first downsampled data and the second downsampled data are generated from the first time-series data and the second time-series data according to the present embodiment. As illustrated in FIG. 23, the first time-series data T1 according to the present embodiment include average angle data T11A, left angle data T11L, right angle data T11R, average angular velocity data T12A, left angular velocity data T12L, and right angular velocity data T12R. The processing portion 45 acquires data on a plurality of arm angles β and data on a plurality of arm angular velocities ω acquired from the discrete value data 46b during the previous period P when acquiring the first time-series data T1. By using these data, the processing portion 45 generates the average angle data T11A, the left angle data T11L, the right angle data T11R, the average angular velocity data T12A, the left angular velocity data T12L, and the right angular velocity data T12R.

The average angle data T11A are time-series data including average values of the arm angles β of the right and left assist arms 13 at the same timings as a plurality of elements. The left angle data T11L are time-series data including the arm angles β (first values) of the left assist arm 13 as a plurality of elements. The right angle data T11R are time-series data including the arm angles β (second values) of the right assist arm 13 as a plurality of elements. The average angular velocity data T12A are time-series data including average values of the arm angular velocities ω of the right and left assist arms 13 at the same timings as a plurality of elements. The left angular velocity data T12L are time-series data including the values of the arm angular velocities ω (first values) of the left assist arm 13 as a plurality of elements. The right angular velocity data T12R are time-series data including the values of the arm angular velocities ω (second values) of the right assist arm 13 as a plurality of elements.

In the manner described above, the processing portion 45 acquires time-series data on average values of the values related to the right and left assist arms 13 and time-series data obtained when the values related to the right and left assist arms 13 are treated individually.

Further, the processing portion 45 generates first downsampled data DD1 by downsampling the first time-series data T1 and the second time-series data T2 at the first downsampling rate. In addition, the processing portion 45 generates second downsampled data DD2 by downsampling the first time-series data T1 and the second time-series data T2 at the second downsampling rate. The first downsampled data DD1 and the second downsampled data DD2 include the following data.
Data obtained by downsampling the average angle data T11A
Data obtained by downsampling the left angle data T11L
Data obtained by downsampling the right angle data T11R
Data obtained by downsampling the average angular velocity data T12A
Data obtained by downsampling the left angular velocity data T12L
Data obtained by downsampling the right angular velocity data T12R
Data obtained by downsampling time-series data on Y-direction acceleration
Data obtained by downsampling time-series data on Z-direction acceleration

Downsampling is performed in the same manner as in the second embodiment. In the present embodiment, the first sampling rate is set to ⅕. The second sampling rate is set to ½.

When the downsampled data DD1 and DD2 are generated in step S21 in FIG. 22, the processing portion 45 executes a process related to operation determination and estimated weight computation (step S30 in FIG. 22).

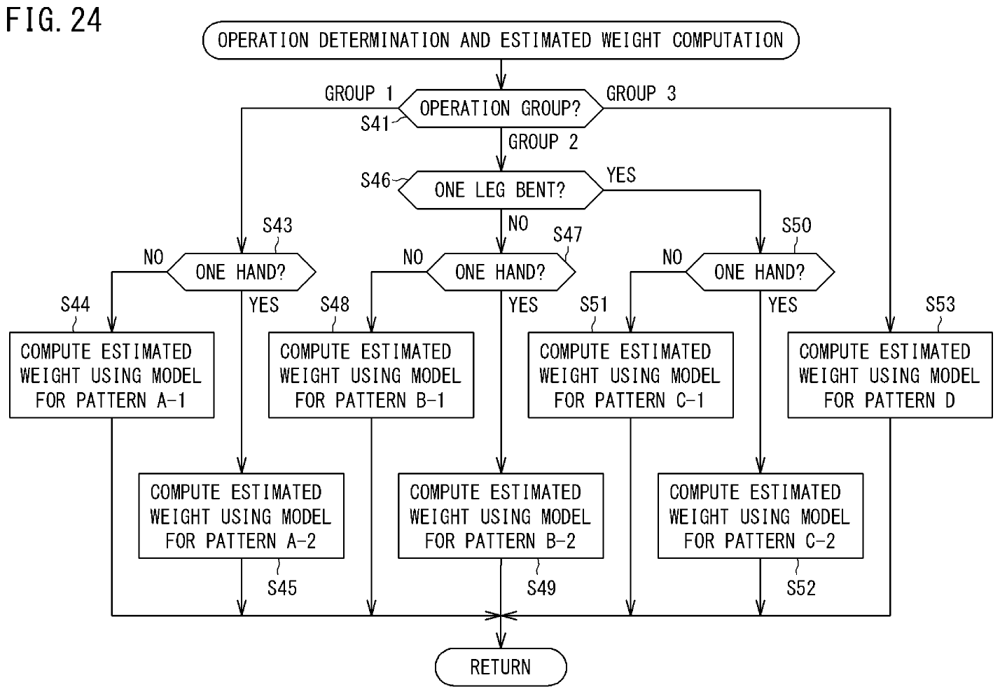

FIG. 24 is a flowchart illustrating a process related to operation determination and estimated weight computation according to the present embodiment. The processing portion 45 proceeds to step S41, and first determines which of the operation groups 1 to 3 the operation of the user U is included in. In step S41, the processing portion 45 uses the first operation determination model 50a (FIG. 20) stored in the storage portion 46.

The first operation determination model 50a (FIG. 20) is a model that has the first downsampled data as an explanatory variable and the operation group as an objective variable.

Teacher data that are used in machine learning of the first operation determination model 50a include the following data obtained when the user U performs load lifting operation in each of the operation patterns in the three operation groups.
Average angle data T11A included in the first time-series data T1
Average angular velocity data T12A included in the first time-series data T1
Second time-series data T2

The teacher data for the first operation determination model 50a are acquired by the user U performing load lifting operation in each of the operation patterns in the three operation groups. The first operation determination model 50a has been subjected to machine learning in advance using the teacher data.

In step S41 in FIG. 24, the processing portion 45 determines based on the following data included in the first downsampled data DD1 which of the operation groups 1 to 3 the operation of the user U corresponds to.
Data obtained by downsampling the average angle data T11A
Data obtained by downsampling the average angular velocity data T12A
Data obtained by downsampling time-series data on Y-direction acceleration
Data obtained by downsampling time-series data on Z-direction acceleration

When it is determined in step S41 that the operation corresponds to the operation group 1, the processing portion 45 proceeds to step S43, and determines whether the user U is lifting a load with one hand or with both hands (step S43 in FIG. 24). That is, the processing portion 45 determines which of the operation pattern A-1 and the operation pattern A-2 the operation of the user U corresponds to. In step S43, the processing portion 45 uses the second operation determination model 50b (FIG. 20) stored in the storage portion 46.

The second operation determination model 50b (FIG. 20) is a model that has the first downsampled data as an explanatory variable and the operation pattern (operation pattern A-1 or operation pattern A-2) as an objective variable.

Teacher data that are used in machine learning of the second operation determination model 50b include the following data obtained when the user U performs load lifting operation in each of the operation pattern A-1 and the operation pattern A-2.
Left angle data TILL included in the first time-series data T1
Right angle data T11R included in the first time-series data T1
Left angular velocity data T12L included in the first time-series data T1
Right angular velocity data T12R included in the first time-series data T1
Second time-series data T2

The teacher data for the second operation determination model 50b are acquired by the user U performing load lifting operation in the two operation patterns. The second operation determination model 50b has been subjected to machine learning in advance using the teacher data.

In step S43 in FIG. 24, the processing portion 45 determines based on the following data included in the first downsampled data DD1 which of the operation pattern A-1 and the operation pattern A-2 the operation of the user U corresponds to.
Data obtained by downsampling the left angle data T11L
Data obtained by downsampling the right angle data T11R
Data obtained by downsampling the left angular velocity data T12L
Data obtained by downsampling the right angular velocity data T12R
Data obtained by downsampling time-series data on Y-direction acceleration
Data obtained by downsampling time-series data on Z-direction acceleration

When it is determined in step S43 that the user U is not lifting a load with one hand (when it is determined that the operation corresponds to the operation pattern A-1), the processing portion 45 proceeds to step S44, and obtains an estimated weight using the first weight estimation model 48a (FIG. 20) stored in the storage portion 46. The processing portion 45 obtains an estimated weight by providing the second downsampled data DD2 to the first weight estimation model 48a.

The first weight estimation model 48a is a model obtained through machine learning of the relationship between the first time-series data T1 and the second time-series data T2 and the weight of the load N at the time when the user U lifts the load N through operation along the operation pattern A-1. Teacher data that are used in machine learning of the first weight estimation model 48a include the following data obtained when the user U performs load lifting operation in the operation pattern A-1.
Average angle data T11A included in the first time-series data T1
Average angular velocity data T12A included in the first time-series data T1
Second time-series data T2

Hence, in step S44, the processing portion 45 obtains an estimated weight using the following data included in the second downsampled data DD2.
Data obtained by downsampling the average angle data T11A
Data obtained by downsampling the average angular velocity data T12A
Data obtained by downsampling time-series data on Y-direction acceleration
Data obtained by downsampling time-series data on Z-direction acceleration

When an estimated weight is obtained in step S44, the processing portion 45 finishes the process, and returns to the process in FIG. 22.

When it is determined in step S43 that the user U is lifting a load with one hand (when it is determined that the operation corresponds to the operation pattern A-2), the processing portion 45 proceeds to step S45, and obtains an estimated weight using the second weight estimation model 48b (FIG. 20) stored in the storage portion 46. The processing portion 45 obtains an estimated weight by providing the second downsampled data DD2 to the second weight estimation model 48b.

The second weight estimation model 48b is a model obtained through machine learning of the relationship between the first time-series data T1 and the second time-series data T2 and the weight of the load N at the time when the user U lifts the load N through operation along the operation pattern A-2. Teacher data that are used in machine learning of the second weight estimation model 48b include the following data obtained when the user U performs load lifting operation in the operation pattern A-2.
Left angle data T11L included in the first time-series data T1
Right angle data T11R included in the first time-series data T1
Left angular velocity data T12L included in the first time-series data T1
Right angular velocity data T12R included in the first time-series data T1
Second time-series data T2

Hence, in step S45, the processing portion 45 obtains an estimated weight using the following data included in the second downsampled data DD2.
Data obtained by downsampling the left angle data T11L
Data obtained by downsampling the right angle data T11R
Data obtained by downsampling the left angular velocity data T12L
Data obtained by downsampling the right angular velocity data T12R
Data obtained by downsampling time-series data on Y-direction acceleration
Data obtained by downsampling time-series data on Z-direction acceleration

When an estimated weight is obtained in step S45, the processing portion 45 finishes the process, and returns to the process in FIG. 22.

When it is determined in step S41 that the operation corresponds to the operation group 2, the processing portion 45 proceeds to step S46, and determines whether the user U is lifting a load while standing on one knee (step S46 in FIG. 24). That is, the processing portion 45 determines which of the operation patterns B-1 and B-2 and the operation patterns C-1 and C-2 the operation of the user U corresponds to. In step S46, the processing portion 45 uses the third operation determination model 50c (FIG. 20) stored in the storage portion 46.

The third operation determination model 50c (FIG. 20) is a model that has the first downsampled data as an explanatory variable and the state of the knee of one leg (whether bent or not) as an objective variable.

Teacher data that are used in machine learning of the third operation determination model 50c include the following data obtained when the user U performs load lifting operation in the operation patterns B-1 and B-2 and the operation patterns C-1 and C-2.
Left angle data T11L included in the first time-series data T1
Right angle data T11R included in the first time-series data T1
Left angular velocity data T12L included in the first time-series data T1
Right angular velocity data T12R included in the first time-series data T1
Second time-series data T2

The teacher data for the third operation determination model 50c are acquired by the user U performing load lifting operation in the four operation patterns. The third operation determination model 50c has been subjected to machine learning in advance using the teacher data.

In step S46 in FIG. 24, the processing portion 45 determines based on the following data included in the first downsampled data DD1 whether the user U is standing on one knee.
Data obtained by downsampling the left angle data T11L
Data obtained by downsampling the right angle data T11R
Data obtained by downsampling the left angular velocity data T12L
Data obtained by downsampling the right angular velocity data T12R
Data obtained by downsampling time-series data on Y-direction acceleration
Data obtained by downsampling time-series data on Z-direction acceleration

When it is determined in step S46 that the user U is not standing on one knee (when it is determined that the operation of the user U corresponds to the operation pattern B-1 or B-2), the processing portion 45 proceeds to step S47, and determines whether the user U is lifting a load with one hand or with both hands (step S47 in FIG. 24). That is, the processing portion 45 determines which of the operation pattern B-1 and the operation pattern B-2 the operation of the user U corresponds to. In step S47, the processing portion 45 uses the fourth operation determination model 50d (FIG. 20) stored in the storage portion 46.

The fourth operation determination model 50d (FIG. 20) is a model that has the first downsampled data as an explanatory variable and the operation pattern (operation pattern B-1 or operation pattern B-2) as an objective variable.

Teacher data that are used in machine learning of the fourth operation determination model 50d include the following data obtained when the user U performs load lifting operation in each of the operation pattern B-1 and the operation pattern B-2.
Left angle data T11L included in the first time-series data T1
Right angle data T11R included in the first time-series data T1
Left angular velocity data T12L included in the first time-series data T1
Right angular velocity data T12R included in the first time-series data T1
Second time-series data T2

The teacher data for the fourth operation determination model 50d are acquired by the user U performing load lifting operation in the two operation patterns. The fourth operation determination model 50d has been subjected to machine learning in advance using the teacher data.

In step S47 in FIG. 24, the processing portion 45 determines based on the following data included in the first downsampled data DD1 which of the operation pattern B-1 and the operation pattern B-2 the operation of the user U corresponds to.
Data obtained by downsampling the left angle data T11L
Data obtained by downsampling the right angle data T11R
Data obtained by downsampling the left angular velocity data T12L
Data obtained by downsampling the right angular velocity data T12R
Data obtained by downsampling time-series data on Y-direction acceleration
Data obtained by downsampling time-series data on Z-direction acceleration

When it is determined in step S47 that the user U is not lifting a load with one hand (when it is determined that the operation corresponds to the operation pattern B-1), the processing portion 45 proceeds to step S48, and obtains an estimated weight using the third weight estimation model 48c (FIG. 20) stored in the storage portion 46. The processing portion 45 obtains an estimated weight by providing the second downsampled data DD2 to the third weight estimation model 48c.

The third weight estimation model 48c is a model obtained through machine learning of the relationship between the first time-series data T1 and the second time-series data T2 and the weight of the load N at the time when the user U lifts the load N through operation along the operation pattern B-1. Teacher data that are used in machine learning of the first weight estimation model 48a include the following data obtained when the user U performs load lifting operation in the operation pattern A-1.
Average angle data T11A included in the first time-series data T1
Average angular velocity data T12A included in the first time-series data T1
Second time-series data T2

Hence, in step S48, the processing portion 45 obtains an estimated weight using the following data included in the second downsampled data DD2.
Data obtained by downsampling the average angle data T11A
Data obtained by downsampling the average angular velocity data T12A
Data obtained by downsampling time-series data on Y-direction acceleration
Data obtained by downsampling time-series data on Z-direction acceleration

When an estimated weight is obtained in step S48, the processing portion 45 finishes the process, and returns to the process in FIG. 22.

When it is determined in step S47 that the user U is lifting a load with one hand (when it is determined that the operation corresponds to the operation pattern B-2), the processing portion 45 proceeds to step S49, and obtains an estimated weight using the fourth weight estimation model 48d (FIG. 20) stored in the storage portion 46. The processing portion 45 obtains an estimated weight by providing the second downsampled data DD2 to the fourth weight estimation model 48d.

The fourth weight estimation model 48d is a model obtained through machine learning of the relationship between the first time-series data T1 and the second time-series data T2 and the weight of the load N at the time when the user U lifts the load N through operation along the operation pattern B-2.

Teacher data that are used in machine learning of the fourth weight estimation model 48d include the following data obtained when the user U performs load lifting operation in the operation pattern B-2.
Left angle data T11L included in the first time-series data T1
Right angle data T11R included in the first time-series data T1
Left angular velocity data T12L included in the first time-series data T1
Right angular velocity data T12R included in the first time-series data T1
Second time-series data T2

Hence, in step S49, the processing portion 45 obtains an estimated weight using the following data included in the second downsampled data DD2.
Data obtained by downsampling the left angle data TILL
Data obtained by downsampling the right angle data T11R
Data obtained by downsampling the left angular velocity data T12L
Data obtained by downsampling the right angular velocity data T12R
Data obtained by downsampling time-series data on Y-direction acceleration
Data obtained by downsampling time-series data on Z-direction acceleration

When an estimated weight is obtained in step S49, the processing portion 45 finishes the process, and returns to the process in FIG. 22.

When it is determined in step S46 that the user U is standing on one knee (when it is determined that the operation of the user U corresponds to the operation pattern C-1 or C-2), the processing portion 45 proceeds to step S50, and determines whether the user U is lifting a load with one hand or with both hands (step S50 in FIG. 24). That is, the processing portion 45 determines which of the operation pattern C-1 and the operation pattern C-2 the operation of the user U corresponds to. In step S50, the processing portion 45 uses the fifth operation determination model 50e (FIG. 20) stored in the storage portion 46.

The fifth operation determination model 50e (FIG. 20) is a model that has the first downsampled data as an explanatory variable and the operation pattern (operation pattern C-1 or operation pattern C-2) as an objective variable.

Teacher data that are used in machine learning of the fifth operation determination model 50e include the following data obtained when the user U performs load lifting operation in each of the operation pattern C-1 and the operation pattern C-2.
Left angle data T11L included in the first time-series data T1
Right angle data T11R included in the first time-series data T1
Left angular velocity data T12L included in the first time-series data T1
Right angular velocity data T12R included in the first time-series data T1
Second time-series data T2

The teacher data for the fifth operation determination model 50e are acquired by the user U performing load lifting operation in the two operation patterns. The fifth operation determination model 50e has been subjected to machine learning in advance using the teacher data.

In step S50 in FIG. 24, the processing portion 45 determines based on the following data included in the first downsampled data DD1 which of the operation pattern C-1 and the operation pattern C-2 the operation of the user U corresponds to.
Data obtained by downsampling the left angle data T11L
Data obtained by downsampling the right angle data T11R
Data obtained by downsampling the left angular velocity data T12L
Data obtained by downsampling the right angular velocity data T12R
Data obtained by downsampling time-series data on Y-direction acceleration
Data obtained by downsampling time-series data on Z-direction acceleration

When it is determined in step S50 that the user U is not lifting a load with one hand (when it is determined that the operation corresponds to the operation pattern C-1), the processing portion 45 proceeds to step S51, and obtains an estimated weight using the fifth weight estimation model 48e (FIG. 20) stored in the storage portion 46. The processing portion 45 obtains an estimated weight by providing the second downsampled data DD2 to the fifth weight estimation model 48e.

The fifth weight estimation model 48e is a model obtained through machine learning of the relationship between the first time-series data T1 and the second time-series data T2 and the weight of the load N at the time when the user U lifts the load N through operation along the operation pattern C-1. Teacher data that are used in machine learning of the fifth weight estimation model 48e include the following data obtained when the user U performs load lifting operation in the operation pattern C-1.
Average angle data T11A included in the first time-series data T1
Average angular velocity data T12A included in the first time-series data T1
Second time-series data T2

Hence, in step S51, the processing portion 45 obtains an estimated weight using the following data included in the second downsampled data DD2.
Data obtained by downsampling the average angle data T11A
Data obtained by downsampling the average angular velocity data T12A
Data obtained by downsampling time-series data on Y-direction acceleration
Data obtained by downsampling time-series data on Z-direction acceleration

When an estimated weight is obtained in step S51, the processing portion 45 finishes the process, and returns to the process in FIG. 22.

When it is determined in step S50 that the user U is lifting a load with one hand (when it is determined that the operation corresponds to the operation pattern C-2), the processing portion 45 proceeds to step S52, and obtains an estimated weight using the sixth weight estimation model 48f (FIG. 20) stored in the storage portion 46. The processing portion 45 obtains an estimated weight by providing the second downsampled data DD2 to the sixth weight estimation model 48f.

The sixth weight estimation model 48f is a model obtained through machine learning of the relationship between the first time-series data T1 and the second time-series data T2 and the weight of the load N at the time when the user U lifts the load N through operation along the operation pattern C-2. Teacher data that are used in machine learning of the sixth weight estimation model 48f include the following data obtained when the user U performs load lifting operation in the operation pattern C-2.
Left angle data T11L included in the first time-series data T1
Right angle data T11R included in the first time-series data T1
Left angular velocity data T12L included in the first time-series data T1
Right angular velocity data T12R included in the first time-series data T1
Second time-series data T2

Hence, in step S52, the processing portion 45 obtains an estimated weight using the following data included in the second downsampled data DD2.
Data obtained by downsampling the left angle data T11L
Data obtained by downsampling the right angle data T11R
Data obtained by downsampling the left angular velocity data T12L
Data obtained by downsampling the right angular velocity data T12R
Data obtained by downsampling time-series data on Y-direction acceleration
Data obtained by downsampling time-series data on Z-direction acceleration

When an estimated weight is obtained in step S52, the processing portion 45 finishes the process, and returns to the process in FIG. 22.

When it is determined in step S41 that the operation corresponds to the operation group 3, the processing portion 45 proceeds to step S53, and obtains an estimated weight using the seventh weight estimation model 48g (FIG. 20) stored in the storage portion 46. In this case, the processing portion 45 can determine that the operation of the user U corresponds to the operation pattern D. In step S53, the processing portion 45 obtains an estimated weight by providing the second downsampled data DD2 to the seventh weight estimation model 48g.

The seventh weight estimation model 48g is a model obtained through machine learning of the relationship between the first time-series data T1 and the second time-series data T2 and the weight of the load N at the time when the user U lifts the load N through operation along the operation pattern D. Teacher data that are used in machine learning of the seventh weight estimation model 48g include the following data obtained when the user U performs load lifting operation in the operation pattern D.
Average angle data T11A included in the first time-series data T1
Average angular velocity data T12A included in the first time-series data T1
Second time-series data T2

Hence, in step S53, the processing portion 45 obtains an estimated weight using the following data included in the second downsampled data DD2.
Data obtained by downsampling the average angle data T11A
Data obtained by downsampling the average angular velocity data T12A
Data obtained by downsampling time-series data on Y-direction acceleration
Data obtained by downsampling time-series data on Z-direction acceleration

When an estimated weight is obtained in step S53, the processing portion 45 finishes the process, and returns to the process in FIG. 22. In the present embodiment, the time-series data (average angle data T11A and average angular velocity data T12A) on the average values of the values related to the right and left assist arms 13 and the time-series data (right and left angle data T11R and T11L and right and left angular velocity data T12R and T12L) obtained when the values related to the right and left assist arms 13 are treated individually are included in the first time-series data T1. Thus, operation of the user U with a lateral difference can be determined as an operation pattern by selectively using such data, and the number of operation patterns to be determined as the operation of the user U can be increased.

In the present embodiment, the operation patterns A-2, B-2, and C-2 in which the user lifts a load with one hand are set. When the user lifts a load with one hand, it is also possible to determine which of the right and left hands is used to lift the load using trained models.

### [Others]

The embodiments disclosed herein are illustrative in all respects and not restrictive. While the second time-series data T2 include the time-series data T21 on the Y-direction acceleration and the time-series data T22 on the Z-direction acceleration in the above embodiments, the second time-series data T2 may further include time-series data on the inclination angle α of the upper body BU and time-series data on the angular velocity of the upper body BU.

While the first time-series data T1 are acquired for each of the right and left assist arms 13 in the first embodiment, the first time-series data T1 may be acquired for one of the right and left assist arms 13, for example. In this case, the amount of data to be processed by the processing portion 45 can be decreased, and the load on the processing portion 45 can be relieved. When the first time-series data T1 are acquired for each of the right and left assist arms 13, determination can be made for each of the right and left assist arms 13, and the precision in estimating an estimated weight can be further enhanced.

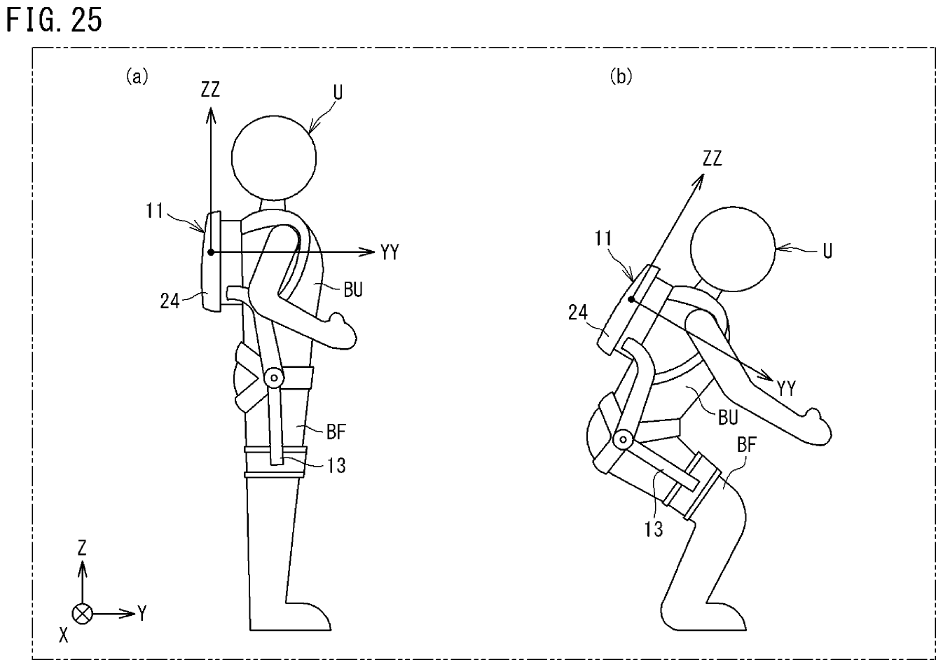

While the processing portion 45 obtains the acceleration in the Y direction at the acceleration sensor 15 and the acceleration in the Z direction at the acceleration sensor 15 based on the output of the acceleration sensor 15 in the above embodiments, acceleration in a direction set with reference to the first wearing tool 11 may be obtained based on the output of the acceleration sensor 15, and used as the discrete value data 46b and the second time-series data T2. That is, as illustrated in FIGS. 25(a) and 25(b), a direction that is parallel to the longitudinal direction of the upper body BU of the user U is set as a ZZ direction with reference to the first wearing tool 11, and a direction that is orthogonal to the ZZ direction and the right-left direction of the user U is set as a YY direction. In this case, the processing portion 45 may obtain acceleration in the YY direction and acceleration in the ZZ direction based on the output of the acceleration sensor 15, and obtain the discrete value data 46b and the second time-series data T2 based on such accelerations.

The scope of the present invention is not limited to the embodiments discussed above, and includes all changes made within the scope of equivalents to the configurations set forth in the claims.

### DESCRIPTION OF THE REFERENCE NUMERALS

10 . . . assist device, 11 . . . first wearing tool, 12 . . . second wearing tool, 13 . . . assist arm, 14 . . . actuator, 15 . . . acceleration sensor, 16 . . . control device, 21 . . . waist support portion, 21a . . . front belt, 21b . . . rear belt, 21c . . . waist side pad, 22 . . . jacket portion, 22a . . . shoulder belt, 22b . . . chest belt, 23 . . . frame cover, 24 . . . backpack portion, 25 . . . turning mechanism, 25a . . . case, 25b . . . shaft portion, 39 . . . frame pipe, 40 . . . motor, 40a . . . output shaft, 40b . . . spiral spring, 41 . . . rotation detector, 42 . . . speed reducer, 42a . . . input shaft, 43 . . . driving pulley, 44 . . . wire, 45 . . . processing portion, 45a . . . control process, 45b . . . estimation process, 45b1 . . . acquisition process, 45b2 . . . determination process, 45b3 . . . weight estimation process, 45b4 . . . muscle torque estimation process, 45b5 . . . generation process, 45b6 . . . operation determination process, 45c . . . retraining process, 45d . . . correction process, 46 . . . storage portion, 46a . . . trained model, 46al . . . first trained model, 46a2 . . . second trained model, 46a3 . . . third trained model, 46b . . . discrete value data, 46c . . . operation determination model, 48 . . . weight estimation model group, 48a . . . first weight estimation model, 48b . . . second weight estimation model, 48c . . . third weight estimation model, 48d . . . fourth weight estimation model, 48e . . . fifth weight estimation model, 48f . . . sixth weight estimation model, 48g . . . seventh weight estimation model, 50 . . . operation determination model group, 50a . . . first operation determination model, 50b . . . second operation determination model, 50c . . . third operation determination model, 50d . . . fourth operation determination model, 50e . . . fifth operation determination model, BB . . . chest, BF . . . thigh portion, BS . . . shoulder portion, BU . . . upper body, BW . . . waist portion, D . . . loading platform, 11 . . . discrete value data, D12 . . . discrete value data, D21 . . . discrete value data, D22 . . . discrete value data, DD1 . . . first downsampled data, DD2 . . . second downsampled data, N . . . load, P . . . previous period, T1 . . . first time-series data, T11 . . . time-series data, T12 . . . time-series data, T2 . . . second time-series data, T21 . . . time-series data, T22 . . . time-series data, Th . . . threshold, U . . . user, g . . . vertical direction line, α . . . inclination angle, β . . . arm angle, γ . . . angle, ω . . . arm angular velocity

1. An assist device comprising:
a first wearing tool mounted to at least a waist portion of a user;
an arm disposed along a thigh portion of the user and being turnable with respect to the first wearing tool;
a motor that generates torque for turning the arm;
a second wearing tool provided on the arm and mounted to the thigh portion;
an acceleration sensor provided on the first wearing tool;
a rotation detector that detects a turning state of the arm; and
a control device that controls the motor, wherein the control device includes a processing portion that executes
an estimation process of obtaining an estimated weight of a load to be lifted by the user based on an output of the acceleration sensor and an output of the rotation detector, and
a control process of controlling the motor based on the estimated weight.

2. The assist device according to claim 1, wherein the estimation process includes
an acquisition process of acquiring the output of the rotation detector and the output of the acceleration sensor over time,
a determination process of determining whether the output of the rotation detector meets a predetermined condition, and
a weight estimation process of obtaining the estimated weight based on first time-series data and second time-series data when it is determined that the output of the rotation detector meets the predetermined condition, the first time-series data being based on a plurality of outputs of the rotation detector acquired in a previous period until a time when the output of the rotation detector that meets the predetermined condition is acquired since a time a predetermined time earlier, and the second time-series data being based on a plurality of outputs of the acceleration sensor acquired in the previous period.

3. The assist device according to claim 2, wherein the predetermined condition is met when an angular velocity of the arm obtained from the output of the rotation detector when the arm is turned in a direction of extending a hip joint of the user becomes more than a threshold set in advance.

4. The assist device according to claim 2, wherein:
the first time-series data include time-series data on an angle of the arm with respect to the first wearing tool and time-series data on an angular velocity of the arm; and
the second time-series data include time-series data on an acceleration in an up-down direction at the acceleration sensor and time-series data on an acceleration in a front-rear direction of the user at the acceleration sensor.

5. The assist device according to claim 2, wherein the weight estimation process includes obtaining the estimated weight using a trained model that has been trained with a relationship between the first time-series data and the second time-series data and a weight of the load.

6. The assist device according to claim 5, wherein the processing portion further executes
a process of receiving teacher data that indicate the relationship between the first time-series data and the second time-series data and the weight of the load, and
a process of retraining the trained model based on the teacher data.

7. The assist device according to claim 1, wherein the estimation process includes
an acquisition process of acquiring the output of the rotation detector and the output of the acceleration sensor over time,
a muscle torque estimation process of obtaining estimated muscle torque for turning the thigh portion exhibited by muscle power of the user based on an inclination angle and an angular velocity of an upper body of the user obtained from the output of the acceleration sensor and an angle and an angular velocity of the arm obtained from the output of the rotation detector,
a determination process of determining whether the output of the rotation detector meets a predetermined condition, and
a weight estimation process of obtaining the estimated weight based on a plurality of estimated muscle torques when it is determined that the output of the rotation detector meets the predetermined condition, the plurality of estimated muscle torques being obtained based on a plurality of outputs of the rotation detector and a plurality of outputs of the acceleration sensor acquired in a previous period until a time when the output of the rotation detector that meets the predetermined condition is acquired since a time a predetermined time earlier.

8. The assist device according to claim 1, wherein the estimation process includes
an acquisition process of acquiring the output of the rotation detector and the output of the acceleration sensor over time,
a determination process of determining whether the output of the rotation detector meets a predetermined condition,
an operation determination process of performing operation determination of operation of the user to lift the load based on first time-series data and second time-series data when it is determined that the output of the rotation detector meets the predetermined condition, the first time-series data being based on a plurality of outputs of the rotation detector acquired in a previous period until a time when the output of the rotation detector that meets the predetermined condition is acquired since a time a predetermined time earlier, and the second time-series data being based on a plurality of outputs of the acceleration sensor acquired in the previous period, and
a weight estimation process of obtaining the estimated weight based on a determination result of the operation determination, the first time-series data, and the second time-series data.

9. The assist device according to claim 8, wherein:
the operation determination process includes determining which of a plurality of operation patterns set in advance the operation of the user to lift the load corresponds to; and
the weight estimation process includes obtaining the estimated weight by selectively using a plurality of trained models that has been trained with a relationship between the first time-series data and the second time-series data and a weight of the load for the plurality of operation patterns.

10. The assist device according to claim 8, wherein:
the estimation process includes a generation process of generating first downsampled data and second downsampled data when it is determined that the output of the rotation detector meets the predetermined condition, the first downsampled data being obtained by downsampling the first time-series data and the second time-series data at a first sampling rate, and the second downsampled data being obtained by downsampling the first time-series data and the second time-series data at a second sampling rate;
the operation determination process includes performing the operation determination based on the first downsampled data; and
the weight estimation process includes obtaining the estimated weight based on the determination result of the operation determination and the second downsampled data.

11. The assist device according to claim 9, wherein:
the processing portion further executes a correction process of correcting the estimated weight obtained through the estimation process using a plurality of sigmoid functions corresponding to the plurality of operation patterns; and
the control process includes using a corrected weight obtained through the correction process as the estimated weight.

12. The assist device according to claim 8, further comprising:
a different arm disposed along a different thigh portion of the user and being turnable with respect to the first wearing tool;
a different motor that generates torque for turning the different arm;
a different second wearing tool provided on the different arm and mounted to the different thigh portion; and
a different rotation detector that detects a turning state of the different arm, wherein:
the acquisition process includes acquiring an output of the different rotation detector over time in addition to the output of the rotation detector and the output of the acceleration sensor; and
the first time-series data include time-series data on a first value based on the output of the rotation detector, time-series data on a second value based on the output of the different rotation detector, and time-series data on an average value of the first value and the second value.
